(19) United States
(12) Patent Application Publication
(10) Pub. No.: US 2017/0124261 A1
(43) Pub. Date: May 4, 2017

(54) SYSTEMS AND METHODS FOR PATIENT HEALTH NETWORKS

(71) Applicant: DocSnap, Inc., Marietta, GA (US)

(72) Inventor: Anthony J. Mari, Marietta, GA (US)

(21) Appl. No.: 15/337,870

(22) Filed: Oct. 28, 2016

Related U.S. Application Data
(60) Provisional application No. 62/247,598, filed on Oct. 28, 2015.

(51) Int. Cl. G06F 19/00; G06Q 10/10

(52) U.S. Cl. CPC G06F 19/322; G06Q 10/1095

(57) ABSTRACT

Systems and methods for permitting secure but effective interactions between medical providers and patients and management of electronic medical records, including access thereto. Generally, a patient health network system is configured to enable one or more patients to join a patient health network that permits the patient to manage his or her electronic medical records, acting a central repository for the same (e.g., receiving electronic medical records from providers, storing those records, transmitting those records to providers as requested, etc.). In one embodiment, the patient health network system also permits a patient and his or her medical providers to interact with each other—scheduling appointments, asking questions (e.g., about a particular condition, follow-up to a consultation, etc.), etc.

### CROSS REFERENCE TO RELATED APPLICATIONS

This application claims priority to, the benefit under 35 U.S.C. §119 of, and incorporates by reference herein in its entirety U.S. Provisional Patent Application No. 62/247,598, filed Oct. 28, 2015, and entitled “Patient Health Network Systems and Related Methods.”

### TECHNICAL FIELD

The present systems and methods relate generally to electronic health records and, more particularly, to provisional of one or more patient health networks for managing provider-patient interactions and electronic health records.

### BACKGROUND

Government regulations (e.g., the Health Insurance Portability and Accountability Act, etc.) severely limit the ability of medical providers (e.g., doctors, hospitals, pharmacies, etc.) to provide access to medical records for a variety of reasons, foremost among them being privacy concerns. As medical records, generally, contain the most sensitive of information, limiting access to medical records is a clumsy manner of attempting to prevent malicious parties from gaining access to the same through restrictions on the channels of communication for medical records, individual authorizations required to transmit/provide access to medical records, etc. Thus, these restrictions often create frustration amongst patients attempting to retrieve, access, gather, or seek further clarity regarding their medical records or those of a related patient. To combat this frustration, these government regulations, seemingly in conflict with their primary goal, also have recently placed mandates on the medical providers to provide their patients with more accessibility to both the medical providers and the medical records.

Therefore, there is a long-felt but unresolved need for a system or method that permits secure but effective interactions between medical providers and patients and secure but effective management of electronic medical records, including access thereto.

### BRIEF SUMMARY OF THE DISCLOSURE

Briefly described, and according to one embodiment, aspects of the present disclosure generally relate to systems and methods for permitting secure but effective interactions between medical providers and patients and management of electronic medical records, including access thereto.

A patient health network system, according to various embodiments, is configured to enable one or more patients to join a patient health network that permits the patient to manage his or her electronic medical records (e.g., known allergies, known conditions, medical history, immunization history, visit summaries, lab results, current medications, prescriptions, most recent vital signs, scheduled and past procedures, etc.). Generally, the patient may then act as the central repository for the entirety of his or her electronic medical records—storing the records in an electronic device (e.g., smart phone, computer, tablet, etc.) or a remote database or data repository (e.g., cloud server, etc.) associated with the system, transmitting the records to medical providers as requested, receiving the medical records from medical providers, etc. Further, in various embodiments, the system permits the patient to interact with his or her medical providers—scheduling appointments, asking questions (e.g., about a particular condition, follow-up to a consultation, etc.), etc. Similarly, in various embodiments, the system permits the medical providers to interact with their patients.

In some embodiments, the system is configured to authenticate (e.g., using two forms of identification, etc.) a patient prior to enabling the patient to join the patient health network. Thus, the system can ensure the identity of a patient to comply with federal regulations, which allows a medical provider to transmit medical records to and communicate with the patient. In one embodiment, the system further enables connections between authenticated patients (e.g., spouses, parents and children, etc.) so that one or more patients may monitor and manage the medical records and interactions with medical providers of another patient. In addition, the system, in one embodiment, permits unrelated authenticated patients to interact with one another.

In one embodiment, a computer-implemented method of facilitating creation of a patient health network, the method comprising: providing a patient health network application to a plurality of patient health network patient members and potential patient members for installation on a computing device associated with each of the plurality of patient members and potential patient members; receiving a request from a potential patient member at a patient vetting server via the patient health network application over the Internet to join the patient health network, the patient vetting server comprising one or more processors and a memory that stores one or more patient vetting requirements and information associated with the potential patient member, wherein the one or more processors: in response to the request from the potential patient member to join the patient health network, authenticate the potential patient member based at least in part on the one or more patient vetting requirements and the information associated with the potential patient member; in response to authenticating the potential patient member, generate first patient member account data for the potential patient member comprising the information associated with the potential patient member and associate the first patient member account data with a first patient member account; and store the first patient member account data in the memory; receiving, via a direct address associated with the patient health network, one or more electronic health records (EHRs) associated with the first patient member at a patient health network server sent from a data source over the Internet, the patient health network server comprising one or more processors and a memory that stores patient member account data for each of the plurality of patient health network patient members and one or more EHRs, wherein the one or more processors: associate, in the memory, the one or more EHRs associated with the first patient member with the first patient member account; receive a request from the first patient member via the patient health network application to view the one or more EHRs associated with the first patient member; in response to the request to view the one or more EHRs associated with the first patient member, transmit the one or more EHRs associated with the first patient member over a wireless communication channel to a computing device associated with the first patient member, wherein: the patient health network application causes the one or more EHRs associated with the first patient member to display on the computing device associated with the first patient member. In one embodiment, a computer-implemented method for forming a secure patient network for transmitting healthcare data between the secure patient network and a secure doctor network, the method comprises: creating, by a processor, a key for a secured patient network; receiving a request, by a processor, from a first patient to establish an account on the secured patient network; at least partially in response to receiving the request, creating, by a processor, an account for the first patient; assigning, by a processor, a sub-key to the first patient, wherein the sub-key is at least partially based on the key; facilitate, by a processor, uploading of patient healthcare information to the first patient's account; storing, by a processor, the uploaded first patient healthcare information in the first patient's account on the secured patient network; receiving, by a processor, from the first patient a request to transmit the uploaded first patient healthcare information to a first doctor having an account on a first secure doctor network; and at least partially in response to receiving the request to transmit the uploaded first patient healthcare information to the first doctor, facilitating, by a processor, transmission of the uploaded first patient healthcare data to the first doctor on the first secure doctor's network.

According to one aspect of the present disclosure, the computer-implemented method, further comprising: receiving, by one or more processors at the patient health network server, a request from the first patient member to transmit a first electronic health record (EHR) to a third party via the patient health network; at least partially in response to receiving the request, formatting the EHR, by the one or more processors, based at least in part one or more clinical document architecture (CDA) standards to generate a formatted EHR; transmitting, by the one or more processors, the formatted EHR over one or more networks to a third party server based on a direct address associated with the third party. Furthermore, the computer-implemented method, further comprising: providing a patient health network application to a plurality of patient health network doctor members for installation on a computing device associated with each of the plurality of patient health network doctor members; enabling, by the one or more processors, the plurality of patient members to connect with one or more of the plurality of doctor members via the patient health network; receiving, at the patient health network server, from the first patient member via the patient health network application, a request to connect to a first doctor member, wherein: in response to receiving the request to connect to the first doctor member, the one or more processors: connect the first patient member to the first doctor member via the patient health network by: associating, by one or more processors the first patient member account with a first doctor member account associated with the first doctor member in memory; and enabling, by one or more processors, secure two-way communication between the first patient member and the first doctor member via the patient health care network application.

According to one aspect of the present disclosure, the computer-implemented method, further comprising: receiving, at the patient health network server, from the first patient member via the patient health network application, a request to transmit a first message to the first doctor member; in response to the request to transmit the first message to the first doctor member, transmitting the first message over one or more networks to a computing device associated with the first doctor member based on one or more Health Insurance Portability and Accountability Act (HIPPA) compliance standards, wherein the patient health network application causes the first message to display on the computing device associated with the first doctor member. Moreover, the computer-implemented method, wherein: the patient heather network server further comprises a memory that stores patient member account data for a second patient member account associated with a second patient member account, third patient member account data for a third patient member associated with a third patient member account, wherein the second patient account data comprises one or more second EHRs associated with the second patient member; and the method further comprises: receiving, by one or more processors at the patient health network server, from the second patient member via the patient health network application, a request to authorize the third patient member to view the second patient member account data; in response to the request to authorize the third patient member to view the second patient member account data, associating, in memory by one or more processors, the second patient member account data with the third patient member account; receiving, by a one or more processors from the third patient member via the patient health network application a request to view the second patient member account data; in response to the request to view the second patient member account data, transmitting, by one or more processors, the second patient member account data over a wireless communication channel to a computing device associated with the third patient member, wherein: the patient health network application causes the second patient member account data to display on the computing device associated with the third patient member while the third patient member is logged into the third patient member account via the patient health network application on the computing device associated with the third patient member.

According to one aspect of the present disclosure, the computer-implemented method, wherein the method further comprises: receiving, by one or more processors at the patient health network server, from the second patient member via the patient health network application, a request to authorize the third patient member to transmit the one or more second EHRs to a third party via the patient health network; at least partially in response to receiving the request, authorizing the third patient member to transmit the one or more second EHRs. Additionally, the computer-implemented method, wherein the method further comprises: receiving, by one or more processors at the patient health network server, from the third patient member via the patient health network application, a request to transmit the one or more second EHRs to t third party via the patient health network; formatting the one or more second EHRs, by the one or more processors, based at least in part on one or more clinical document architecture (CDA) standards to generate one or more formatted second EHRs; and transmitting, by the one or more processors, the one or more formatted second EHRs over one or more networks to a third party server based.

According to one aspect of the present disclosure, the computer-implemented method, wherein: the patient heather network server further comprises a memory that stores patient member account data for a fourth patient member account associated with a fourth patient member account, fifth patient member account data for a fifth patient member associated with a fifth patient member account, wherein the fourth patient account data comprises one or more fourth EHRs associated with the fourth patient member; and the method further comprises: receiving, by one or more processors at the patient health network server, from the fifth patient member via the patient health network application, a request for authorization to view the fourth patient member account data; in response to the request for authorization to view the fourth patient member account data, confirming an authority of the fifth patient member to view healthcare data for the fourth patient member; in response to confirming the authority of the fifth patient member to view healthcare data for the fourth patient member, associating, in memory by one or more processors, the fourth patient member account data with the fifth patient member account; receiving, by a one or more processors from the fifth patient member via the patient health network application a request to view the fourth patient member account data; in response to the request to view the fourth patient member account data, transmitting, by one or more processors, the fourth patient member account data over a wireless communication channel to a computing device associated with the fifth patient member, wherein: the patient health network application causes the fourth patient member account data to display on the computing device associated with the fifth patient member while the fifth patient member is logged into the fifth patient member account via the patient health network application on the computing device associated with the fifth patient member. Also, the computer-implemented method, wherein: the fifth patient member is a parent of the fourth patient member; and the fourth patient member is minor child.

According to one aspect of the present disclosure, the computer-implemented method, wherein the step of storing the uploaded first patient healthcare information further comprises: automatically formatting, by a processor, the uploaded healthcare information into a standard healthcare record format; and appending the formatted healthcare information to an electronic healthcare record for the first patient in the first patient's account. Moreover, the computer-implemented method, further comprising the step of: receiving, by a processor, information from a second doctor having an account on a second secure doctor network; automatically parsing, by a processor, the received information for a second sub-key contained in the received information, wherein the second sub-key is at least partially based on the key; determining, by a processor, a second patient assigned the second sub-key; formatting, by a processor, the received information into a standard healthcare record format; and storing, by a processor, the formatted information in an account for the second patient associated with the second sub-key.

According to one aspect of the present disclosure, the computer-implemented method, wherein the first sub-key and the second-sub-key are the same sub-key and the second patient is the same as the first patient. Additionally, the computer-implemented method, further comprising: receiving, by a processor, from the first patient, a request to authorize a second user having an account on the secured patient network to view the first patient healthcare information; at least partially in response to receiving the request, authorizing the second user to view the first patient healthcare information. Also, the computer-implemented method, further comprising: providing, by a processor, a patient health application for installation on a computing device associated with the second user; receiving, by a processor, from the second user via the patient health application, a request to view the first patient healthcare information; at least partially in request to receiving the request to view the first patient healthcare information, causing the patient health application to display the first patient healthcare information on the computing device associated with the second user.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a high-level overview of an exemplary patient health network, according to one embodiment of the present disclosure.

FIG. 2 illustrates architectural details of an exemplary patient health network, according to one embodiment of the present disclosure.

FIG. 3 is an exemplary schematic showing an exemplary computer that is suitable for use in various embodiments of the present disclosure.

FIG. 4 is a flowchart showing an exemplary account creation process, according to one embodiment of the present disclosure.

FIG. 5 is a flowchart showing an exemplary electronic health record transmission and receipt process, according to one embodiment of the present disclosure.

FIG. 6 is a flowchart showing an exemplary medical provider interaction process, according to one embodiment of the present disclosure.

FIG. 7 is a flowchart showing an exemplary account access permission process, according to one embodiment of the present disclosure.

FIG. 8 is a screenshot of an exemplary home page of a patient health network, according to one embodiment of the present disclosure.

FIG. 9 (consisting of FIGS. 9A, 9B, 9C, 9D, 9E, 9F, 9G, and 9H) is a screenshot of an exemplary records page of a patient health network, according to one embodiment of the present disclosure.

FIG. 10 (consisting of FIGS. 10A and 10B) is a screenshot of an exemplary messages page of a patient health network, according to one embodiment of the present disclosure.

FIG. 11 (consisting of FIGS. 11A, 11B, and 11C) is a screenshot of an exemplary providers page of a patient health network, according to one embodiment of the present disclosure.

FIG. 12 (consisting of FIGS. 12A and 12B) is a screenshot of an exemplary provider application, according to one embodiment of the present disclosure.

FIG. 13 is a screenshot of an exemplary patient application, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to systems and methods for permitting secure but effective interactions between medical providers and patients and management of electronic medical records, including access thereto.

A patient health network system, according to various embodiments, is configured to enable one or more patients to join a patient health network that permits the patient to manage his or her electronic medical records (e.g., known allergies, known conditions, medical history, immunization history, visit summaries, lab results, current medications, prescriptions, most recent vital signs, scheduled and past procedures, etc.). Generally, the patient may then act as the central repository for the entirety of his or her electronic medical records—storing the records in an electronic device (e.g., smart phone, computer, tablet, etc.) or a remote database or data repository (e.g., cloud server, etc.) associated with the system, transmitting the records to medical providers as requested, receiving the medical records from medical providers, etc. Further, in various embodiments, the system permits the patient to interact with his or her medical providers—scheduling appointments, asking questions (e.g., about a particular condition, follow-up to a consultation, etc.), etc. Similarly, in various embodiments, the system permits the medical providers to interact with their patients.

In some embodiments, the system is configured to authenticate (e.g., using two forms of identification, etc.) a patient prior to enabling the patient to join the patient health network. Thus, the system can ensure the identity of a patient to comply with federal regulations, which allows a medical provider to transmit medical records to and communicate with the patient. In one embodiment, the system further enables connections between authenticated patients (e.g., spouses, parents and children, etc.) so that one or more patients may monitor and manage the medical records and interactions with medical providers of another patient. In addition, the system, in one embodiment, permits unrelated authenticated patients to interact with one another.

### Exemplary Embodiments

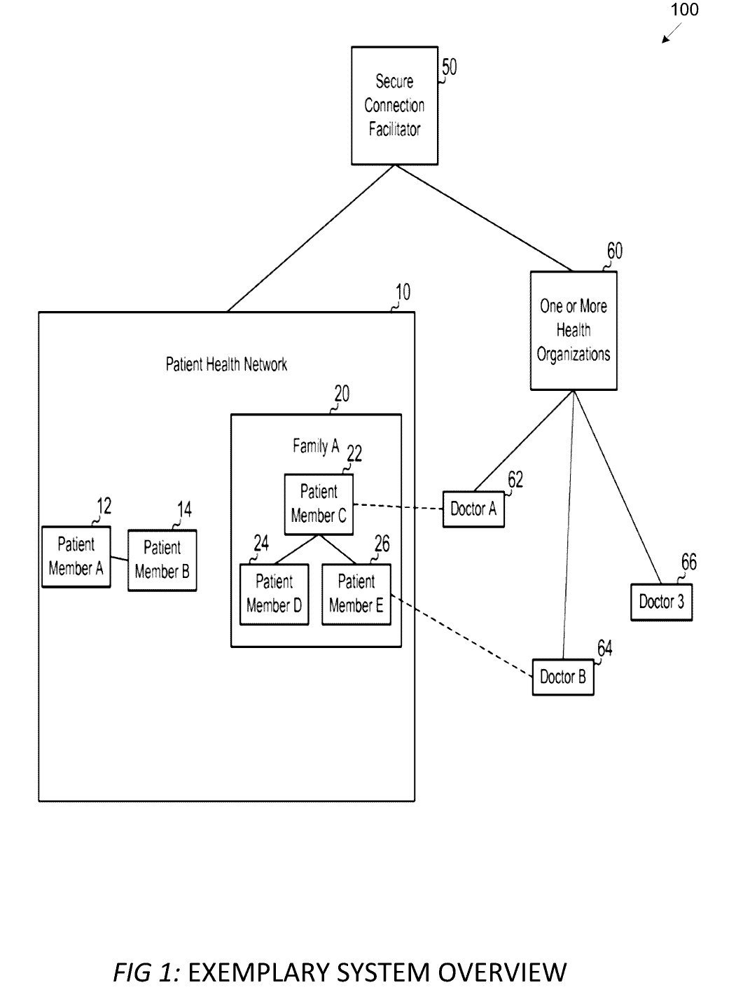

Referring now to the figures, for the purposes of example and explanation of the fundamental processes and components of the disclosed systems and methods, reference is made to FIG. 1, which illustrates an exemplary, high-level overview 100 of one embodiment of a Patient Health Network 10. As will be understood and appreciated, the exemplary, high-level overview 100 shown in FIG. 1 represents merely one approach or embodiment of the present system, and other aspects are used according to various embodiments of the present system.

Generally, the Patient Health Network 10 comprises a plurality of patient members (e.g., Patient Member A 12, Patient Member B 14, Patient Member C 22,

Patient Member D 24, and Patient Member E 26, etc.) who are enabled to manage their electronic medical records and interactions with their medical providers (e.g., Doctor A 62, Doctor B 64, etc.). Although FIG. 1 depicts five patient members in the Patient Health Network 10, it should be understood the embodiment of a Patient Health Network shown in FIG. 1 is for illustrative purposes. Other embodiments of a Patient Health Network 10 may include any suitable number of patient members (e.g., a plurality of patient members).

Within the Patient Health Network 10, in various embodiments, a particular patient member may be enabled to function as a central repository for his or her electronic medical records (e.g., known allergies, known conditions, medical history, immunization history, visit summaries, lab results, current medications, prescriptions, most recent vital signs, scheduled and past procedures, etc.). Thus, the patient may then control access to these electronic medical records, receiving and transmitting them as appropriate to third parties as described herein.

In various embodiments, the system is configured to enable patient members to form various types of connections within the Patient Health Network 10. For example, in various embodiments, patient members (e.g., Patient Member A 12 and Patient Member B 14) may connect with one another or groups of patient members for any suitable reason. For example, in various embodiments, the system is configured to enable patient members to connect with other patient members who may, for example, have similar medical conditions or medical issues. In such embodiments, the system may be configured to enable communication to connected patient members in order to share health and lifestyle tips, stories, encouragement, and other suitable information with one another.

In still other embodiments, the system is configured to enable patient members to form other types of connections. For example, in various embodiments, the system is configured to enable a patient member to appoint another patient member as an agent (e.g., a legal representative) that the patient member has authorized to view private medical information (e.g., electronic health records, alternatively referred to herein as “EHRs,” “EMRs,” or “electronic medical records”) and other patient health network account data associated with the patient member. In still other embodiments, the system is configured to enable a patient member to request access to another patient member's account information for whom the patient member is a legal guardian (e.g., parent, grandparent, etc.). In still other embodiments, a patient member requesting or being provided access to patient network account data for another patient member may be any patient member having a suitable need or suitable legal standing to view the health information and other patient health network account data associated with the one other patient member (e.g., a social worker, guardian ad litem, etc.).

FIG. 1 generally shows Family A 20 comprising patient member C, Patient Member D 24, and Patient Member E 26. In the embodiment shown in this Figure, Patient Member A 20 may be a parent or guardian of Patient Members D and E 24, 26, who may, for example, be minor children. In such an embodiment, Patient Member C 22 may be able to access medical records and other medical information stored as part of the Patient Health Network for Patient Member D 24 and Patient Member E 26. In this embodiment, Patient Members D and E 24, 26 may, for example, be unable to view any medical information or other patient network account data for Patient member C 22 (e.g., the agency relationship between Patient Member C 22 and Patient Members D and E 24, 26 may be a one-way relationship within the Patient Health Network).

As may be understood from FIG. 1, the system is configured to provide a connection between the Patient Health Network 10 and One or More Health Organizations 60, for example, via a Secure Connection Facilitator 50. In various embodiments, the Secure Connection Facilitator may include any suitable Health Information Services Provider (HISP) such as, for example, Medicity. In particular embodiments, the Secure Connection Facilitator 60 may enable substantially secure (e.g., secure) transmission of medical documents between the Patient Health network and third parties (e.g., One or More health Organizations 60, Doctors, etc.). As may be understood by one skilled in the art, electronic transfer of medical records may be subject to particular security requirements, for example, under the Health Insurance Portability and Accountability Act (HIPPA) or other guidelines. In various embodiments, the Secure Connection Facilitator 60 may enable the Patient Health Network 10 to send and receive medical documents on behalf of patient members in a manner that complies with such particular security requirements.

The One or More Health Organizations 60 shown in FIG. 1 may include, for example, one or more hospitals, one or more practice groups, one or more Health Information Exchanges (HIES), etc. In various embodiments, the One or More Health Organizations 60 may include (e.g., oversee) one or more doctors (e.g., Doctor A 62, Doctor B 64, Doctor C 66), such as in a private doctor network. In particular embodiments, the system is configured to enable communication between patient members of the Patient Health Network 10 and the one or more doctors. For example, the system may be configured to enable two-way-communication between Patient Member C 22 and Doctor A 62, for example: (1) directly; (2) via the Secure Connection Facilitator 50; (3) via the One or More Health Organizations 60; and/or (4) via both the Secure Connection Facilitator 50 and the One or More Health Organizations 60. In still other embodiments, doctors (e.g., such as Doctor A 62, Doctor B 64, Doctor C 66) may be included as members of the Patient Health Network. In such embodiments, the system may be configured to enable member doctors to form connections with particular patient members within the Patient Health Network.

In various embodiments, the Patient Health Network 10 may act as a lowest legal entity for liability purposes in the transfer of medical documents and other privileged medical information. For example, as mentioned above, patient members of the Patient Health Network may desire to transfer medical documents stored in their patient member account to one or more third parties (e.g., doctors, etc.). In such embodiments, the Patient Health Network 10 may take legal responsibility for the secure transfer of such medical records.

### Example Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

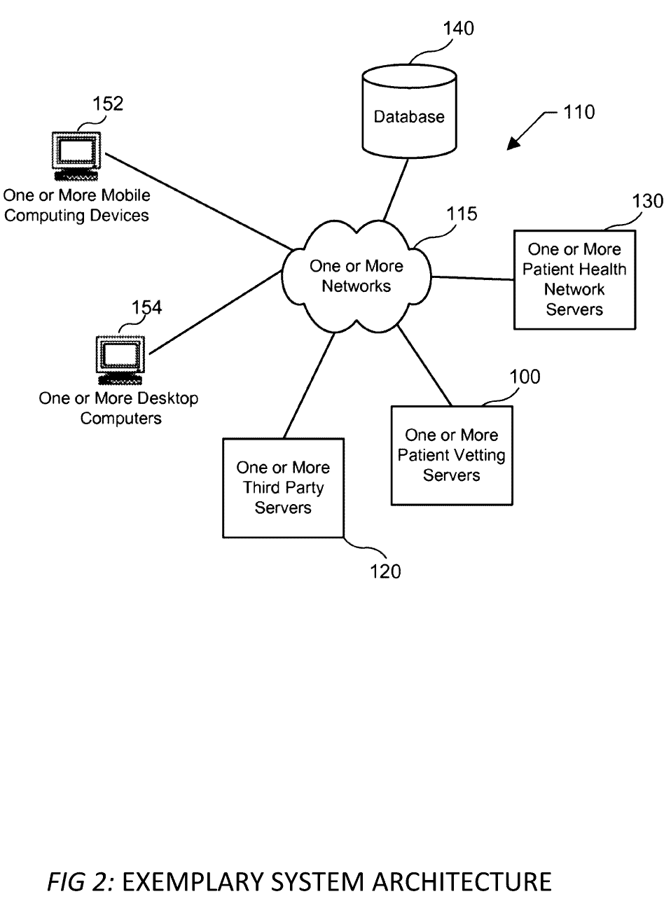

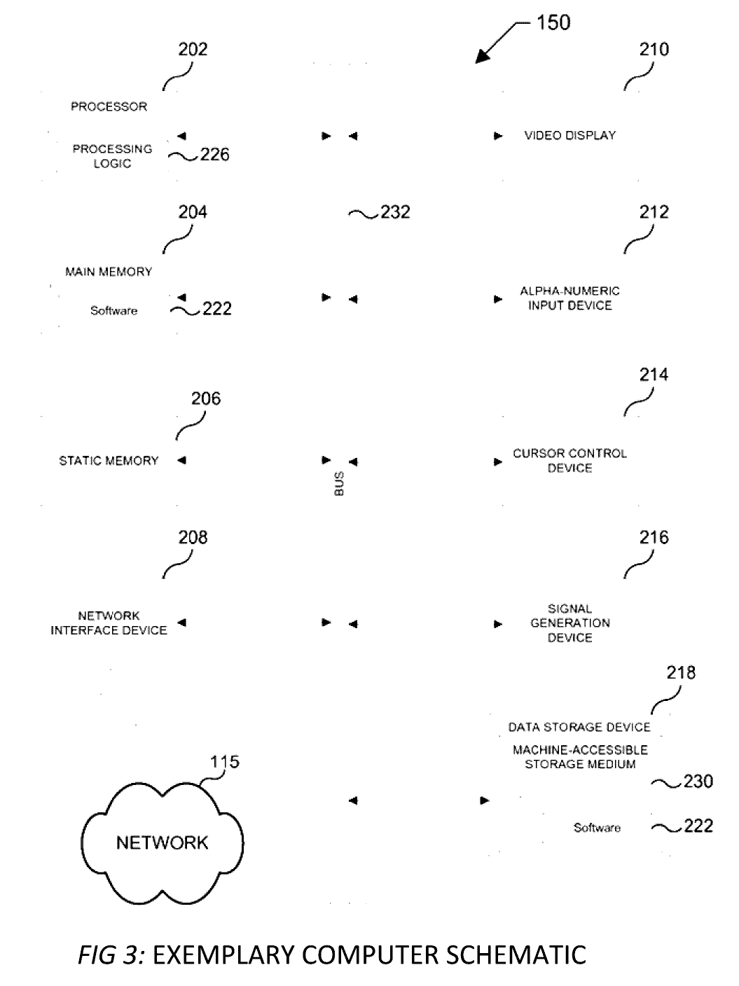

FIG. 2 illustrates architectural details of an exemplary Patient Health Network System 110 according to one particular embodiment of the present disclosure. As may be understood from this figure, the Patient Health Network System 110 includes One or More Networks 115, One or More Patient Health Network Servers 100, One or More Third Party Servers 120, One or More Patient Vetting Servers 130, a Database 140, and one or more remote computing devices, such as a Mobile Computing Device 152 (e.g., a smart phone, a tablet computer, a wearable computing device, a laptop computer, etc.), or a Desktop Computer 154. Further details of the mobile computing device 152 and the desktop computer 154 will be provided in association with the description of FIG. 3. Generally, the Patient Health Network System 110 may be built with SMART® on FHIR® open platform architecture from Harvard Medical School and Boston Children's Hospital or any other architecture that enables integration between electronic medical record systems that contain data in different formats (e.g., a system deployed by Cerner Corporation in comparison to a system developed by McKesson Corporation or Epic Systems Corporation), such as HL7® FHIR® from Health Level Seven International, Open API Standards, etc. As will occur to one having ordinary skill in the art, this open architecture enables the Patient Health Network System 110 to store, receive from, and transmit to any electronic medical record system that may be deployed by the one or more health organizations 60.

In particular embodiments, the One or More Networks facilitate communication between the One or More Patient Health Network Servers 130, One or More Third Party Servers 120, One or More Patient Vetting Servers 100, the Database 140, and the one or more remote computing devices 152, 154. The one or more computer networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between the One or More Patient Health Network Servers 100 and Database 140 may be, for example, implemented via a Local Area Network (LAN), cell network, Bluetooth, the Internet, etc.

In various embodiments, the One or More Patient Health Network Servers 130 any computing device (e.g., desktop computer, laptop, servers, tablets, etc.), combination of computing devices, software, hardware, combination of software and hardware, database (e.g., stored in the cloud or on premise, structured as relational, etc.), or combination of databases that is capable of performing the functionality disclosed herein. In one embodiment, the One or More Patient Health Network Servers 130 may comprise the One or More Patient Vetting Servers 100. In various embodiments, the One or More Third Party Servers 120 any computing device (e.g., desktop computer, laptop, servers, tablets, etc.), combination of computing devices, software, hardware, combination of software and hardware, database (e.g., stored in the cloud or on premise, structured as relational, etc.), or combination of databases that is capable of performing the functionality disclosed herein.

The database 140, in one embodiment, may be any computing device (e.g., desktop computer, laptop, servers, tablets, etc.), combination of computing devices, software, hardware, combination of software and hardware, database (e.g., stored in the cloud or on premise, structured as relational, etc.), or combination of databases that is capable of performing the functionality disclosed herein. In one embodiment, the database 140 is local to the one or more mobile computing devices 152 or one or more desktop computers 154 (e.g., the one or more mobile computing devices 152 or one or more desktop computers 154 comprise the database 140). In one embodiment, the database 140 stores the electronic medical records of one or more patients.

FIG. 3 is an exemplary schematic showing an exemplary computer that is suitable for use in various embodiments of the present disclosure, for example, as a client computer (e.g., one of the remote computing devices 152, 154 shown in FIG. 2) or as a server computer (e.g., One or More Patient Health Network Servers 130 shown in FIG. 2). In particular embodiments, the Computer 120 may be suitable for use as a computer within the context of the System 110 that is configured for collecting, transmitting, receiving, and storing electronic medical records data.

In particular embodiments, the Computer 150 may be connected (e.g., networked) to other computers in a LAN, an intranet, an extranet, and/or the Internet. As noted above, the Computer 150 may operate in the capacity of a server or a client computer in a client-server network environment, or as a peer computer in a peer-to-peer (or distributed) network environment. The Computer 150 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An example Computer 120 includes a Processor 202, a Main Memory 204 (e.g., read-only memory (ROM), flash memory, dynamic random access memory (DRAM) such as synchronous DRAM (SDRAM) or Rambus DRAM (RDRAM), etc.), a Static Memory 206 (e.g., flash memory, static random access memory (SRAM), etc.), and a Data Storage Device 218, which communicate with each other via a Bus 232.

The Processor 202 represents one or more general-purpose or specific Processors such as a microprocessor, a central processing unit, or the like. More particularly, the Processor 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The Processor 202 may also be one or more special-purpose Processors such as an application specific integrated circuit (ASIC), a field programmable gate array (FPGA), a digital signal processor (DSP), network processor, or the like. The Processor 202 may be configured to execute Processing Logic 226 for performing various operations and steps discussed herein.

The Computer 150 may further include a Network Interface Device 208. The Computer 120 also may include a Video Display 210 (e.g., a liquid crystal display (LCD) or a cathode ray tube (CRT)), an Alpha-Numeric Input Device 212 (e.g., a keyboard), a Cursor Control Device 214 (e.g., a mouse), and a Signal Generation Device 216 (e.g., a speaker).

The Data Storage Device 218 may include a Machine-Accessible Storage Medium (e.g., a non-transitory computer-accessible storage medium) 230 (also known as a non-transitory computer-readable storage medium or a non-transitory computer-readable medium) on which is stored one or more sets of instructions (e.g., Software 222) embodying any one or more of the methodologies or functions described herein. The Software 222 may also reside, completely or at least partially, within the Main Memory 204 and/or within the Processor 202 during execution thereof by the Computer 150—the Main Memory 204 and the Processor 202 also constituting computer-accessible storage media. The Software 222 may further be transmitted or received over a Network 115 via a Network Interface Device 208.

While the Machine-Accessible Storage Medium 230 is shown in an example embodiment to be a single medium, the terms “computer-accessible storage medium” and “computer-readable medium” should be understood to include a single medium or multiple media (e.g., a centralized or distributed database, and/or associated caches and servers) that store the one or more sets of instructions. The terms “computer-accessible storage medium” and “computer-readable medium” should also be understood to include any medium (e.g., non-transitory medium) that is capable of storing, encoding or carrying a set of instructions for execution by the Computer 150 and that cause the Computer 150 to perform any one or more of the methodologies of the present invention. The terms “computer-accessible storage medium” and “computer-readable medium” should accordingly be understood to include, but not be limited to, solid-state memories, optical and magnetic media, etc.

### Exemplary System Platform

Various embodiments of a patient healthcare network system may be implemented within the context of any suitable system (e.g., such as a health information service). In particular embodiments, the system may be implemented as part of a software application for accessing medical and other data for one or more people in a particular group (e.g., such as a family). In particular embodiments, the system may be provided by a medical facility, insurance carrier, or other suitable provider of medical information and/or care. In particular embodiments, the system is embodied as a unified software application (e.g., an app for a mobile computing device) from which the user can retrieve secure healthcare information, consumer information, family information, news, or other suitable information as well as communicate with other connected patient health network members. Various aspects of the system's functionality may be executed by certain system modules, including a Patient Health Network Patient Account Creation Module 400, an Electronic Health Record Transmission Module 500, a Patient Health Network Doctor Interaction Module 600, and a Patient Health Network Patient Account Access Permissions Module 700. These modules are discussed in greater detail below. Patient Health Network Patient Account Creation Module

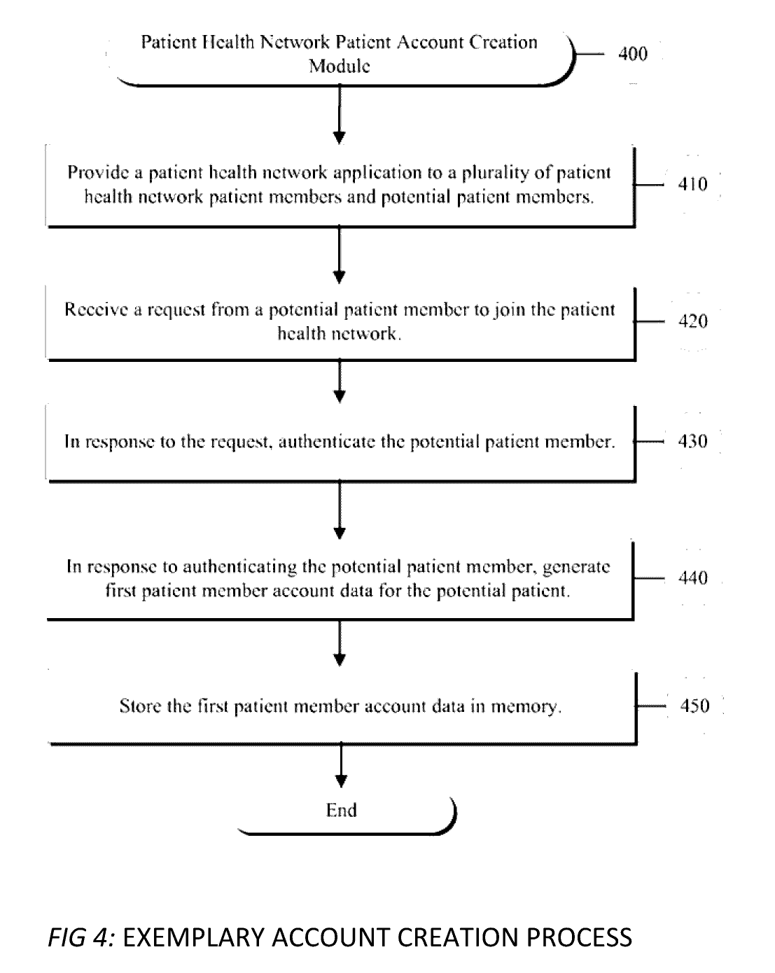

FIG. 4 is a flowchart showing an exemplary account creation process performed by an exemplary Patient Health Network Patient Account Creation Module 400, according to one embodiment of the present disclosure. In particular embodiments, the Patient Health Network Patient Account Creation Module 400 may facilitate creation of a patient member account within the patient health network. For example, the Patient Health Network Patient Account Creation Module 400 may authenticate a potential new patient health network member, generate a new patient member account for the patient member, and store account data and medical information associated with the patient member. In various embodiments, the Patient Health Network Patient Account Creation Module 400 is executed as part of a software application stored locally on a computing device (e.g., a mobile computing device 152 from FIG. 2). In other embodiments various steps of the Patient Health Network Patient Account Creation Module 400 are performed by one or more remote servers (e.g., such as the One or More Patient Health Network Severs 130 or the One or More Patient Vetting Servers 100 from FIG. 2). As will be understood by one having ordinary skill in the art, the steps and processes shown in FIG. 4 (and those of all other flowcharts and sequence diagrams shown and described herein) may operate concurrently and continuously, are generally asynchronous and independent, and are not necessarily performed in the order shown.

When executing the Patient Health Network Patient Account Creation Module 400, the system begins in various embodiments, at Step 410, by providing a patient health network application to a plurality of patient health network patient members and potential patient members. In various embodiments, the system is configured to provide the health network application for download via a suitable website, software exchange, software application store, etc. In particular embodiments, the system is configured to provide the patient health network application for installation on a computing device (e.g., such as a smartphone or tablet computer) associated with each of the plurality of patient members and potential patient members. In particular embodiments, the system is configured to provide access to the patient health network for the patient members via the patient health network application.

Continuing at Step 420, the system is configured, in various embodiments, to receive a request from a potential patient member to join the patient health network. In particular embodiments, the system is configured to receive the request at a patient vetting server (e.g., such as the One or More Patient Vetting Servers 100) from a computing device associated with the potential patient member via the patient health network application. In various embodiments, the system is configured to receive the request over the Internet or over any other suitable network. In particular embodiments, the patient vetting server (e.g., or patient vetting servers) comprises one or more processors and a memory that stores one or more patient vetting requirements and information associated with the potential patient member.

In particular embodiments, the one or more patient vetting requirements may include one or more requirements for acceptance into the patient health network so that medical providers may communicate directly with an enrolled patient in compliance with federal regulations (e.g., HIPAA). The one or more patient vetting requirements may include, for example, one or more requirements to provide identifying information and/or one or more requirements to confirm identifying information (e.g., by providing, by the potential patient member, a government-issued identification card such as a driver's license or social security card), or any other suitable patient vetting requirements. In one embodiment, the vetting requirements may be at least two steps: providing identifying information and providing confirming identifying information (e.g., taking a photo of a driver's license with the application and then receiving confirmation from a medical doctor already registered with the system that the individual identified within the driver's license is in fact the particular patient, providing a copy of a driver's license and then taking a photo so that the system may use facial recognition software to confirm that the photos match, etc.). In one embodiment, the patient may also have to answer one or more security questions (e.g., date of birth, mother's maiden name, previous addresses, etc.) as part of or in addition to the vetting requirements; generally, these security questions may have been pre-established by the patient in the doctor's office or may be randomly generated by the system based on information regarding the patient. In particular embodiments, the system is configured to receive the one or more patient vetting requirements and store the one or more patient requirements in the memory. The system may, for example, receive the one or more patient vetting requirements from the patient health network (e.g., from an administrator of the patient health network) or from any other suitable source.

In particular embodiments, the system receives the information associated with the potential patient member as part of the request to join the patient health network. In other embodiments, the system may request the information associated with the potential patient member in response to the request to join the patient health network. In various embodiments, the information associated with the potential patient member comprises any suitable information such as, for example: (1) legal name; (2) address; (3) contact information (e.g., telephone number, email address, etc.); (4) medical history information; (5) social security number; and/or (6) any other suitable information.

Returning to Step 430, in various embodiments, the system continues by, in response to receiving the request to join the patient health network, authenticating the potential patient member. In various embodiments, the system is configured to authenticate the potential patient member based at least in part on the one or more patient vetting requirements and the information associated with the potential patient member.

For example, the system may be configured to confirm an identity of the potential patient member as part of authenticating the potential patient member. As may be understood by one skilled in the art, because of the sensitive nature of medical information and privacy concerns relating to medical information, it may be important to vet (e.g., confirm the identity of a particular individual) potential new members of the patient health network (e.g., to prevent or reduce a risk of potential improper or unlawful disclosure of private medical information).

Continuing to Step 440, in various embodiments, the system continues by, at least partially in response to authenticating the potential patient member, generating first patient member account data for the potential patient. In various embodiments, the first patient member account data includes any suitable data such as, for example: (1) the information associated with the potential patient member; (2) password and username data; (3) one or more electronic health records associated with the potential patient member; (4) additional patients who should have access to the first patient member's account; (5) additional patients whose accounts the first patient member should be able to access; etc. In various embodiments, the system is configured to associate the first patient member account data with a first patient member account in the patient health network.

Next, at Step 450, in various embodiments, the system stores the first patient member account data in the memory (e.g., in memory associated with the One or More Patient Health Network Severs 130 or any other suitable memory). In one embodiment, after storing the first patient member account data in the memory, the system also generates a DirectTrust email account or other secure and verified email address, so that a medical provider may communicate securely and directly with the patient.

In particular embodiments, when creating a new patient member account, the system is configured to assign a secure key to the patient member (e.g., unique identifier for the new patient member account). In particular embodiments, the secure key is a sub-key derived from or corresponding to a secure key associated with the patient health network (e.g., unique identifier for the particular patient health network). In particular embodiments, the system is configured to generate the secure key (e.g., sub-key and/or secure key associated with the patient health network) using a random number generator, encryption algorithm (e.g., RSA, Blowfish, AES, etc.), cryptographic hash function (e.g., SHA-256, etc.), or any other suitable method. In still other embodiments, the system is configured to assign a secure key to the patient member that was generated or provided by a third party (e.g., such as a HISP). In various embodiments, the assignment of a secure key to a patient member (e.g., by associating the secure key with the newly created patient member account) may enable the system to properly direct EHRs and other documents received by the patient health network (e.g., as discussed herein).

Although the above module is described with respect to a potential patient member joining the patient health network, it should be understood that in various other embodiments, the system may be configured to perform similar steps to enroll one or more doctor members in the patient health network (e.g., enable one or more doctor members to join the patient health network). For example, in one embodiment, the system may request a notarized copy or photo of the enrolling doctor member's government-issued identification and a notarized identification of the enrolling doctor member's national provider identifier number. Generally, in this embodiment, the system may use a third-party certificate authority to verify the gathered information prior to generating the doctor member's account.

In still other embodiments, the system may be configured to utilize such a module to enable any suitable potential member to join the patient health network (e.g., hospital administrator, insurance provider representative, legal guardian, etc.).

### Electronic Health Record Transmission Module

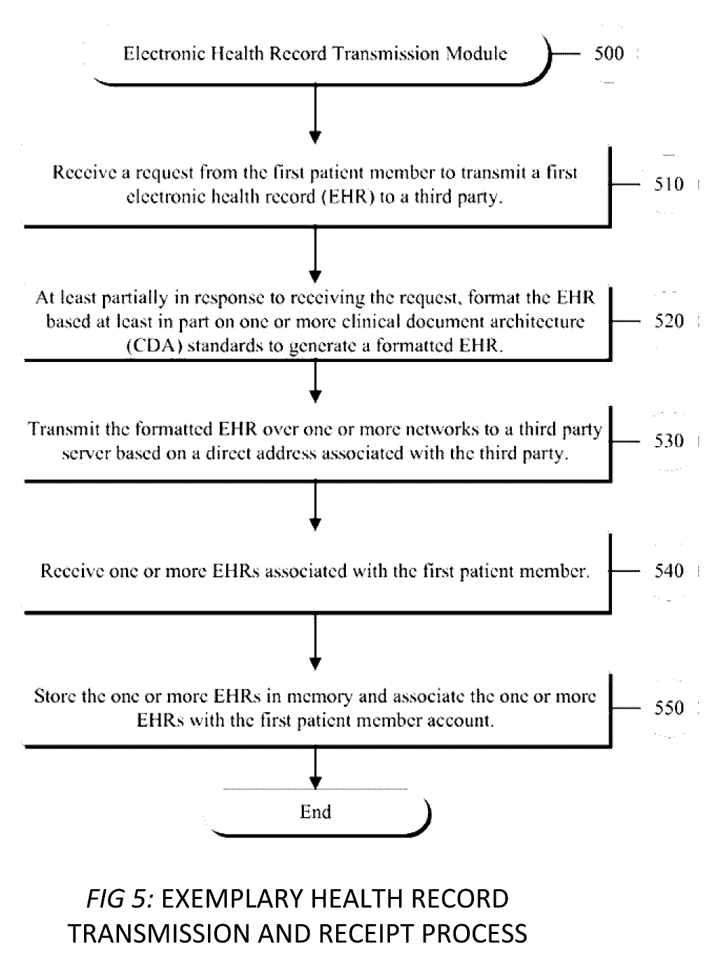

FIG. 5 is a flowchart showing an exemplary electronic health record transmission and receipt process performed by an exemplary Electronic Health Record Transmission Module 500, according to one embodiment of the present disclosure. In particular embodiments, the Electronic Health Record Transmission Module 500 may facilitate a secure transmission of EHRs over a network to or from a third party (e.g., or from one patient health network patient member to another, from one patient health network doctor member to a patient member, or from one patient health network patient member to a doctor member).

When executing the Electronic Health Record Transmission Module 500, the system generally begins, at Step 510, by receiving a request from the first patient member to transmit a first electronic health record to a third party. In various embodiments, the third party is any suitable third party such as a doctor, hospital, etc. In various embodiments, the first electronic health record includes any suitable clinical document such as, for example, a discharge summary, an imaging report, an admission report, a physical report, a pathology report, or any other suitable document or record.

In particular embodiments, the system is configured to receive the request at a patient health network server (e.g., such as the One or More Patient Health Network Servers 100). The system may, for example, receive the request via a mobile computing device (e.g., or other computing device) associated with the first patient member via the patient heath network application. In particular embodiments, the request is a request to transfer one or more EHRs associated with the first patient member account (e.g., one or more EHRs stored by the patient health network in memory associated with the One or More Patient Health Network Servers 130). In particular embodiments, the request is a request to transmit the first EHR via the patient health network. In particular embodiments, the system is configured to enable the first patient member to upload the first EHR prior to transmission (e.g., from a computing device associated with the first patient member).

Continuing to step 520, in various embodiments, the system at least partially in response to receiving the request, formats the EHR based at least in part on one or more clinical document architecture (CDA) standards to generate a formatted EHR. In various embodiments, as will be understood by one skilled in the art, EHR formatting may vary from one provider to another (e.g., or from one EHR to another). In various embodiments, the one or more CDA standards include an XML-based markup standard which may, for example, specify encoding, structure and semantics of clinical documents (e.g., EHRs) for exchange so that an EHR from one system with a particular format may be imported seamlessly and automatically into a system with a different format. CDA standards may be provided, for example, by Health Level Seven International (“HL7”), a Michigan based non-profit organization involved in the development of international healthcare informatics interoperability standards, such as FHIR®. The one or more CDA standards may, for example, specify particular characteristics of a clinical document (e.g., EHR) such as, for example: (1) persistence; (2) stewardship; (3) potential for authentication; (4) context; (5) wholeness; and (6) human readability.

In various embodiments, the one or more CDA standards may include allowing any suitable formatting other than XML (e.g., XHTML). In particular embodiments, the one or more CDA standards may include a requirement to format the first EHR using consolidated-clinical document architecture (C-CDA) or any other suitable architecture. In various embodiments, the one or more CDA standards may include a standardized content and structure for clinical documents. In various embodiments, CDA documents may be made up of the following parts: (1) a header (which may, for example, enable exchange of clinical documents within and across institutions); and (2) a body (which may, for example, contain a clinical report which may include a clinical report or structured content in one or more sections). In various embodiments, the body may further include: (1) sections (which may contain allergies, medications, problems, immunizations, vital signs, care provisions, diagnostics, procedures, referrals, conditions, etc.); (2) a narrative block (which may, for example, include a ‘human readable’ part of a CDA document such as clinical impressions, risk assessments, care plans, goals, detected issues, family history, etc.); and (3) one or more entries (which may include structured machine-readable content for further computer processing such as observations, reports, orders, imaging studies, images, specimens, etc.).

Generally, in one embodiment, the system, at step 520, also formats the electronic health record in an easily-readable format (e.g., portable document format or PDF, etc.) so that the EHR need not be imported into an EHR system to be viewed by the recipient. As will occur to one having ordinary skill in the art, the easily-readable format, however, cannot generally be imported into an EHR system.

Returning to Step 530, in various embodiments, the system transmits the formatted EHR and the easily-readable EHR over one or more networks to a third party server. Generally, the system may transmit the EHRs to any third party regardless of whether that party is registered with the system (e.g., if a doctor who is not registered requests an EHR from a patient who is registered and provides that patient with an email address or other form of contact information, etc.). In one embodiment, the system may be configured to transmit the EHRs to any contact information provided by the third party. In particular embodiments, the system is configured to transmit the formatted EHR using any suitable technique such as, for example, using HL7 version 2 messages, HL7 version 3 message, HL7 FHIR, one or more Integrated the Healthcare Enterprise (IHE) protocols (e.g., such as Cross Enterprise Document Sharing (CDS)), or any other suitable mechanism (e.g., DICOM, MIME attachments to email, http, or ftp).

In various embodiments, the system is configured to transmit the formatted EHR based at least in part on a DirectTrust address associated with the third party. A DirectTrust address may include for example, any suitable encryption standard for securely exchanging clinical healthcare data via the internet. A DirectTrust address may, for example, be associated with a specific hospital, provider, clinician, patient, laboratory, pharmacy, long term care facility, specialist, care team member, etc. In various embodiments, DirectTrust addresses and other DirectTrust messaging services are provided, managed, and published/or by a Health Information Service Provider (HISP).

In various embodiments, the Electronic Health Record Transmission Module 500 may further be configured, at Step 540, to receive one or more EHRs (e.g., one or more clinical documents) associated with the first patient member. In various embodiments, the system is configured to receive the one or more EHRs from the first patient member themselves. In other embodiments, the system is configured to receive the one or more EHRs from another member of the patient health network (e.g., a doctor member). In still other embodiments, the system is configured to receive the one or more EHRs from one or more third parties, for example, via a DirectTrust address associated with the patient health network, a DirectTrust address associated with the patient health network patient member, or any other suitable source. In still other embodiments, the system is configured to receive the one or more EHRs based on any suitable secure key associated with the patient health network (e.g., unique identifier for the particular patient health network). In particular embodiments, the one or more received EHRs are encoded with a sub-key associated with the first patient member (e.g., unique identifier for the first patient member within the particular patient health network), such as the sub-key described above in association with the description of FIG. 4.

In particular embodiments, the system is configured to receive, via a DirectTrust address (e.g., or other secure key) associated with the patient health network, the one or more EHRs associated with the first patient member at a patient health network server (e.g., the One or More Patient Health Network Servers 130) from a data source over the Internet. In various embodiments, the data source may include any suitable data source associated with a doctor, hospital, or any other suitable data source that may have been in possession of the first patient's one or more EHRs (e.g., EHR system, email from doctor, etc.). In various embodiments, the system is configured at Step 550 to store the one or more received EHRs in memory and associate, in memory, the one or more received EHRs with the first patient member account.

In particular embodiments the system is then configured to receive a request from the first patient member via the patient health network application to view the one or more EHRs. In response to the request, the system is configured to transmit the one or more EHRs over a wireless communication channel to a computing device associated with the first patient member. In particular embodiments, the patient health network application is then configured to cause the one or more EHRs associated with the first patient member to display on the computing device associated with the first patient member (e.g., through a user interface that makes up part of the patient health network application).

### Patient Health Network Doctor Interaction Module

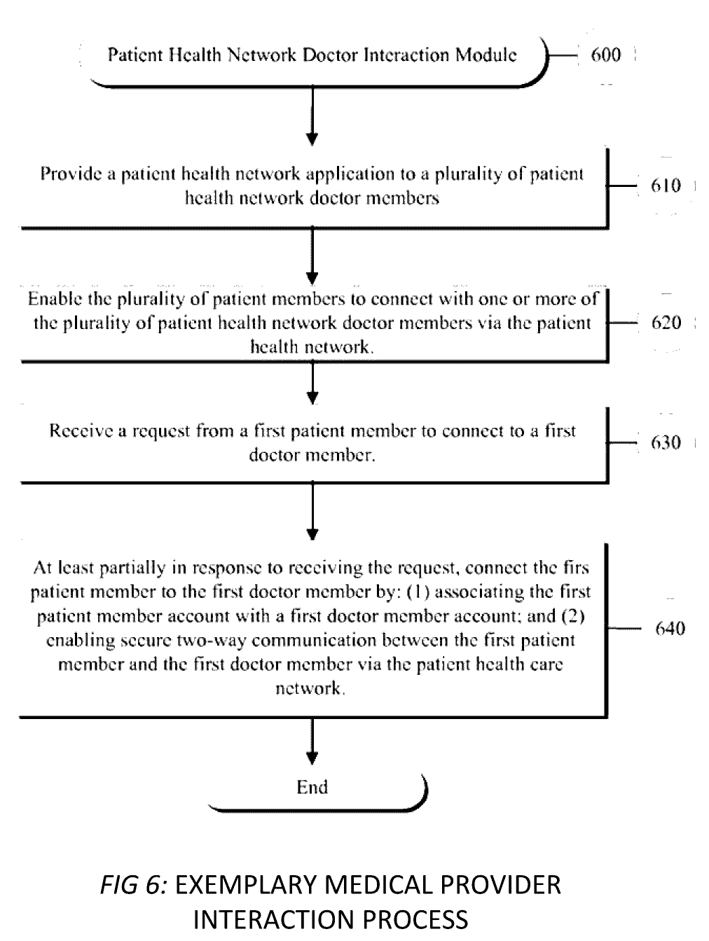

FIG. 6 is a flowchart showing an exemplary medical provider interaction process performed by an exemplary Patient Health Network Doctor Interaction Module 600, according to one embodiment of the present disclosure. In particular embodiments, the Patient Health Network Doctor Interaction Module 600 may facilitate two-way communication between a doctor member of the patient health network and one or more patient members. This may include, for example, enabling two-way, direct communication that complies with one or more heightened security standards for messaging that involves confidential medical information.

When executing the Patient Health Network Doctor Interaction Module 600, the system begins, at Step 610, in various embodiments, by providing a patient health network application to a plurality of patient health network doctor members. In various embodiments, the system is configured to provide the health network application for download via a suitable website, software exchange, software application store, etc. In particular embodiments, the system is configured to provide the patient health network application for installation on a computing device (e.g., such as a smartphone or tablet computer) associated with each of the plurality of patient health network doctor members. In particular embodiments, the system is configured to provide access to patient health network for the doctor members via the patient health network application.

Continuing to Step 620, the system is configured to enable the plurality of patient health network patient members to connect with one or more of the plurality of patient health network doctor members via the patient health network. The system may for example, be configured to enable patients and or doctors to search for particular patients or doctors by name via the patient healthcare network application. The system may then be configured to enable the patient and/or doctor to select an indicia or use any other suitable technique to enable a user to request to connect with another patient health network account holder. At Step 630, the system receives a request from a first patient member to connect to a first doctor member. At least partially in response to receiving the request, the system at Step 640 connects the first patient member to the first doctor member via the patient health network by: (1) associating the first patient member account with a first doctor member account in memory; and (2) enabling secure, two-way communication between the first patient member and the first doctor member via the patient health care network application (e.g., telephone call, video chat, text message, text chat, etc.). In various embodiments, the system is further configured to enable patient members to connect with other patient members in addition to connecting with doctors via the patient health network.

In various embodiments, the system is configured to enable users to connect with other users who may, for example, have similar medical conditions or medical issues. In such embodiments, users may be able to connect with others who may be in a similar situation to share tips, stories, encouragement, and other suitable information with one another. In particular embodiments, the system is configured to enable a user to opt in to a patient connection program. In some embodiments, the system is configured to enable the user to opt in to the patient connection program for one or more particular ailments (e.g., particular types of cancer, asthma, etc.). The system may, for example; (1) receive a request from a first user to connect with one or more other users who share at least one medical condition; (2) at least partially in response to receiving the request, determine at least one second user that shares the at least one medical condition; and (3) at least partially in response to determining the at least one second user, enabling the first and at least one second user to connect with one other. In various embodiments, enabling the first and at least one second user to connect with one another may include enabling the first and at least one second user to send one or more messages to one another. In particular embodiments, the users may provide information about dietary recommendations for dealing with the at least one medical condition, provide support in dealing with the at least one medical condition, etc.

In various embodiments, the system is configured to determine the at least one second user based at least in part on: (1) an age of the first user and the at least one second user; (2) a gender of the first use and the at least one second user; (3) a location of the first user and the at least one second user; etc. The system may, for example, determine the at least on second user such that the first user and second user are somewhat similar in age (e.g., within a few years of each other, are the same gender, etc. In some embodiments, determining at least one second user with similar medical conditions and of a similar age, etc. may enable the system to connect users that will be in a better position to help one another.

In a particular example, the system may connect two user that suffer from psoriasis. The system may then enable the users to communicate regarding particular topical ointments that have proved useful in managing and treating breakouts of psoriasis, dietary restrictions that have limited breakouts, etc. In other embodiments, the system may enable the users to provide support in coping with psoriasis (e.g., social stigmas, etc.) and other issues which may result from having psoriasis such as, for example, depression, self-esteem issues, etc.

Although the Patient Health Network Doctor Interaction Module 600 above is described particularly with respect to connections and communication between: (1) a patient member and a patient member; or (2) a doctor member and a patient member, it should be understood that various embodiments of the system may be configured to enable connection between one or more doctors as well as groups of patients. In particular embodiments, the system is configured to enable connected users to share particular user account data with one or more users with whom they are connected. For example, a particular patient member may share location, age, and other information about themselves with users with whom they have connected and share a similar illness with. The patient members my, for example, elect to share any non-private medical information that makes up part of their patient member account (e.g., such as one or more photos, interests, fitness or diet goals, health information, etc.).

### Patient Health Network Patient Account Access Permissions Module

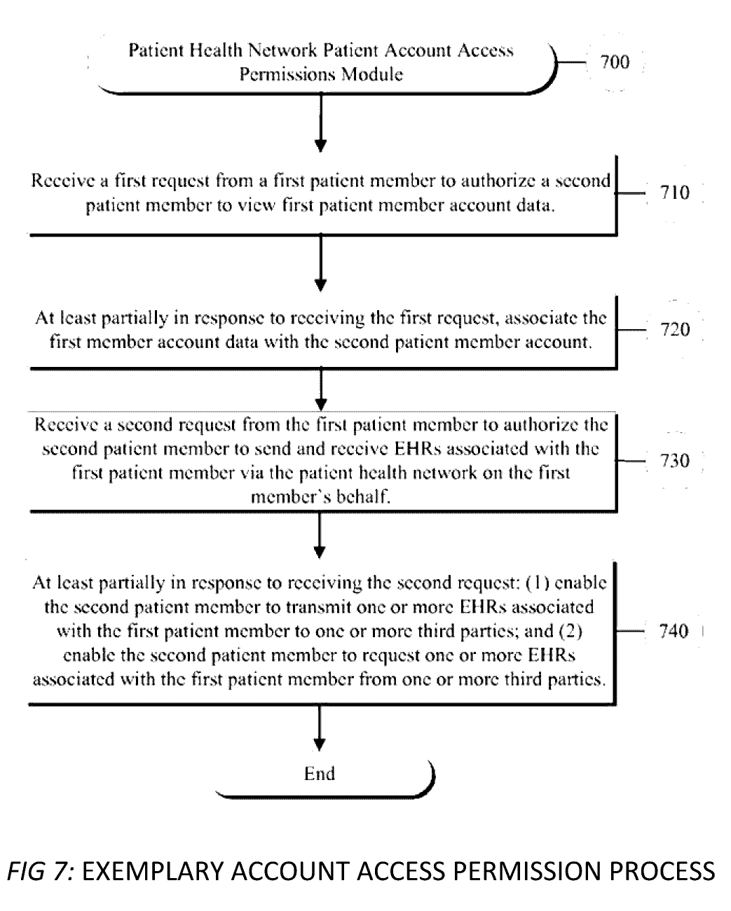

FIG. 7 is a flowchart showing an exemplary account access permission process performed by an exemplary Patient Health Network Patient Account Access Permissions Module 700, according to one embodiment of the present disclosure. In particular embodiments, the Patient Health Network Patient Account Access Permissions Module 700 may enable a first patient health network patient member to authorize a second patient member to act as their agent in the patient health network. This may include for example, providing access to private medical information (e.g., clinical documents) to the second patient member, enabling the second patient member to send and/or receive EHRs on their behalf, and/or communicate with one or more doctors associated with the first patient member on the first patient member's behalf via the patient health network. This may include, for example, enabling two-way, direct communication that complies with one or more heightened security standards for messaging that involves confidential medical information. This module may enable family members to manage health information for a loved one (e.g., a child, elderly parent etc.) or allow a person having a medical power of attorney over another to manage their medical care on their behalf.

When executing the Patient Health Network Patient Account Access Permissions Module 700, the system generally begins, at Step 710, by receiving a first request form a first patient member to authorize a second patient member to view first patient member account data. In various embodiments, the system is configured to receive the request at a patient health network server (e.g., the One or More Patient health Network Servers 100) from the first patient via the patient health network application installed on a computing device associated with the first patient member. The system continues, at Step 720, by at least partially in response to receiving the first request, associating the first member account data with the second patient member account. Associating the first member account data with the second patient member account data may, for example, enable the second patient member to view the first member account data from their second patient member account (e.g., using the patient health application). In various embodiments, the system is configured to store the association in memory. In various embodiments, the first member account data associated with the second patient member account includes private health information such as, for example, one or more clinical documents associated with the first patient member.

In various other embodiments, the system continues, at Step 730, by receiving a second request from the first patient member to authorize the second patient member so send and/or receive EHRs associated with the first patient member via the patient health network on the first patient member's behalf. At Step 740, in response to receiving the second request, the system is configured to: (1) enable the second patient member to transmit one or more EHRs associated with the first patient member to one or more third parties (e.g., as generally discussed above in relation to the Electronic Record Transmission Module 500); and (2) enable the second patient member to request one or more EHRs associated with the first patient member from one or more third parties.

In still other embodiments, the system is configured to enable the first patient member to authorize the second patient member to communicate with one or more doctors with whom the first patient member is connected via the patient health network (e.g., because the first patient member is a patient oft eh one or more connected doctors).

In various other embodiments, the second patient member may request authorization from the system to access first patient member health data, send/receive EHRs on behalf of the first patient member, etc. In such embodiments, the system may be configured to authenticate the second patient member's authorization to view private health data associated with the first patient member and make medical decisions on their behalf. In particular embodiments, for example, the system may require proof of a relationship between the first patient member and second patient member (e.g., parent/child, etc.), an executed medical power of attorney, or any other suitable proof of authorization.

### Exemplary User Interface

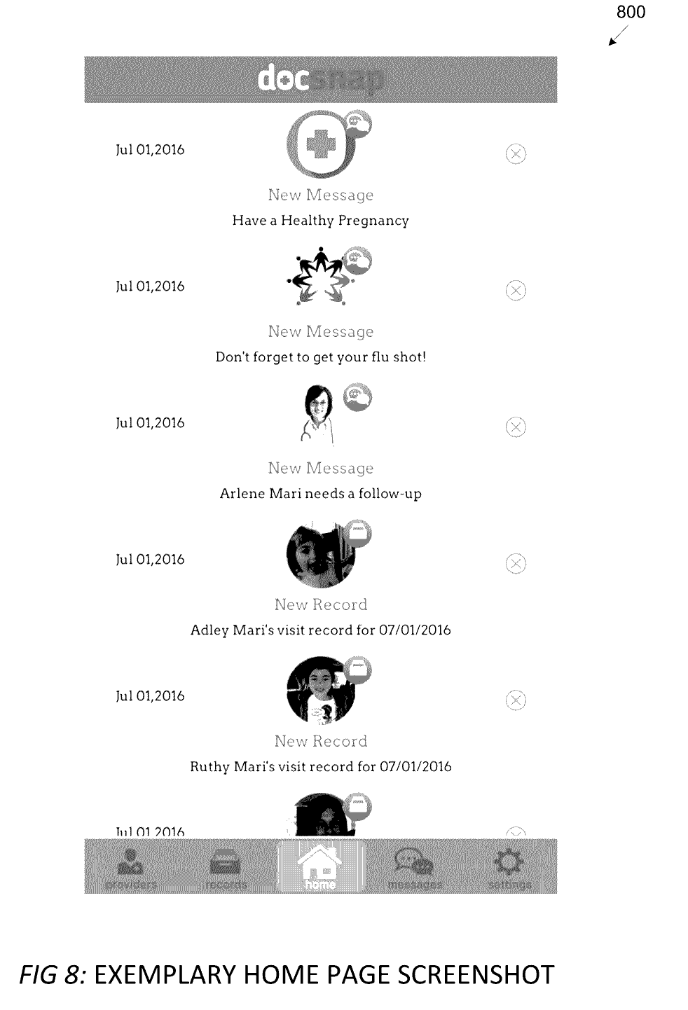

FIGS. 8-13 depict screenshots of a user interface that a user of the patient health network may use to access the patient health network according to a particular embodiment. As may be understood from these figures, a user interface for accessing the patient health network according to a particular embodiment may display useful information associated with the patient's patient health network account in a streamlined, chronological manner for easy viewing.

FIG. 8 is a screenshot of an exemplary home page 800 of a patient health network, according to one embodiment of the present disclosure. Generally, the patient may view and select the most recent information regarding that patient (e.g., new messages, new medical records, upcoming appointments, etc.) or navigate to different pages within the patient health network (e.g., providers page, records page, messages page, etc.).

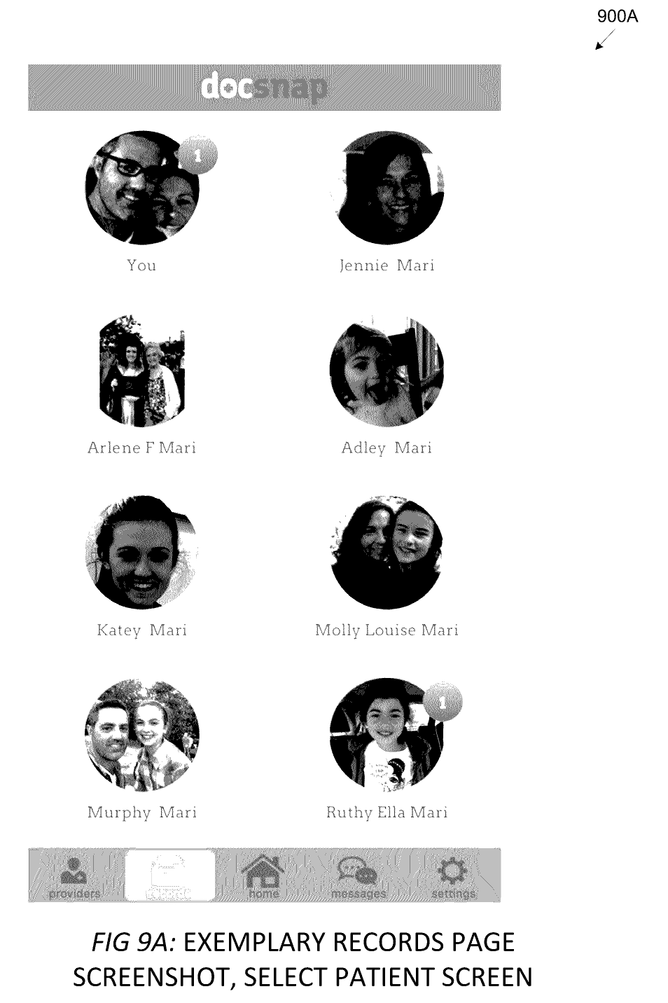

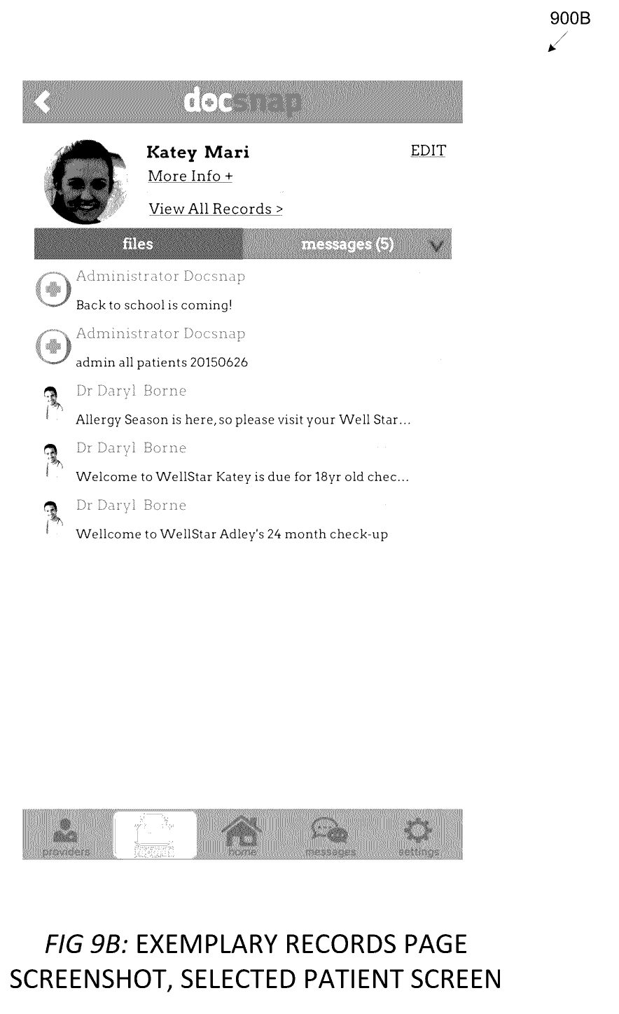

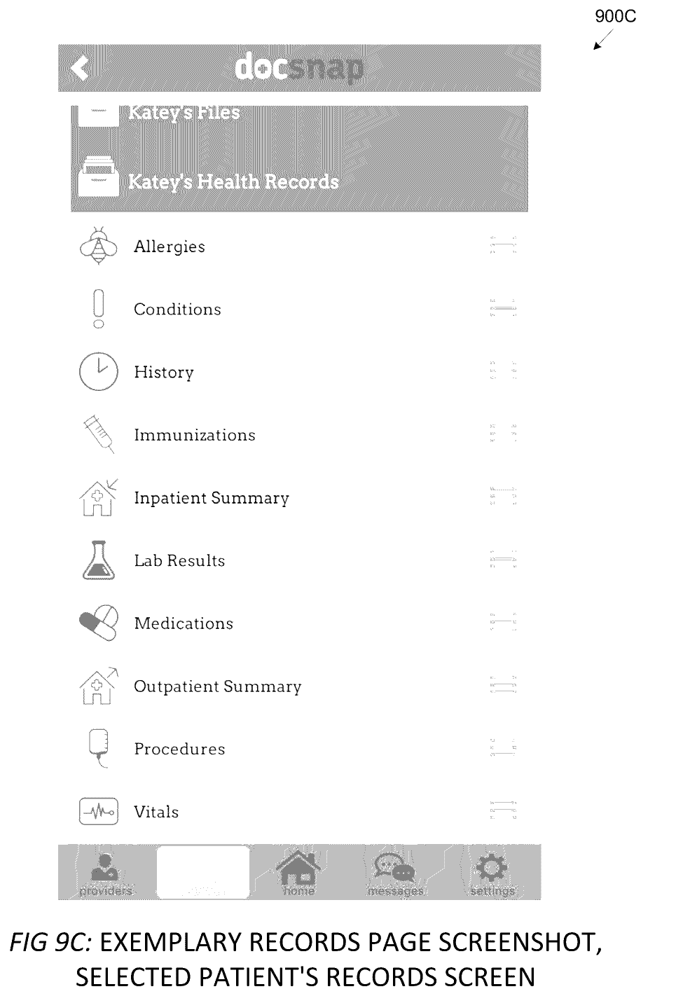

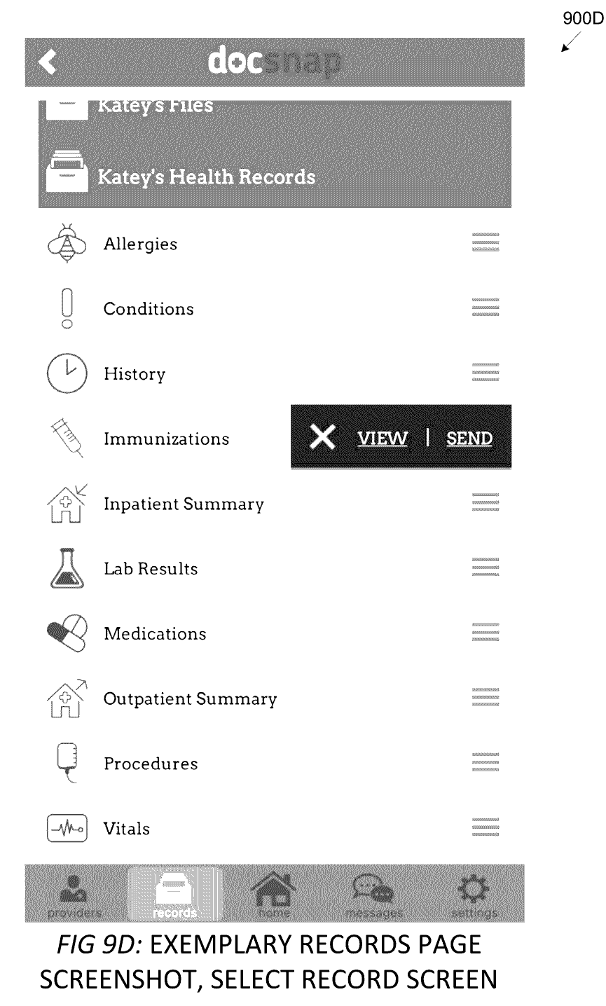

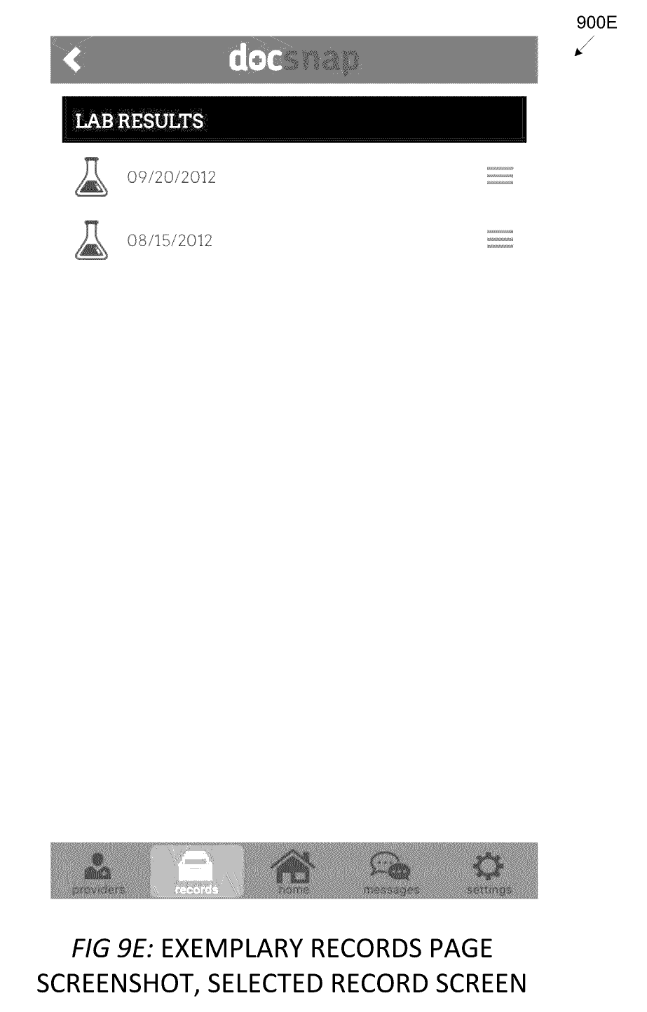

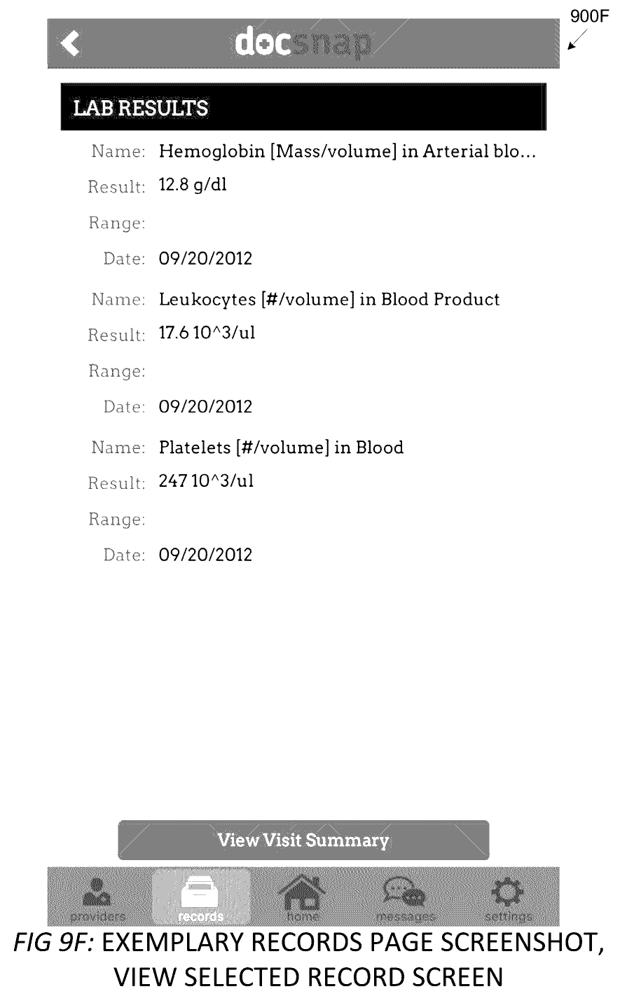

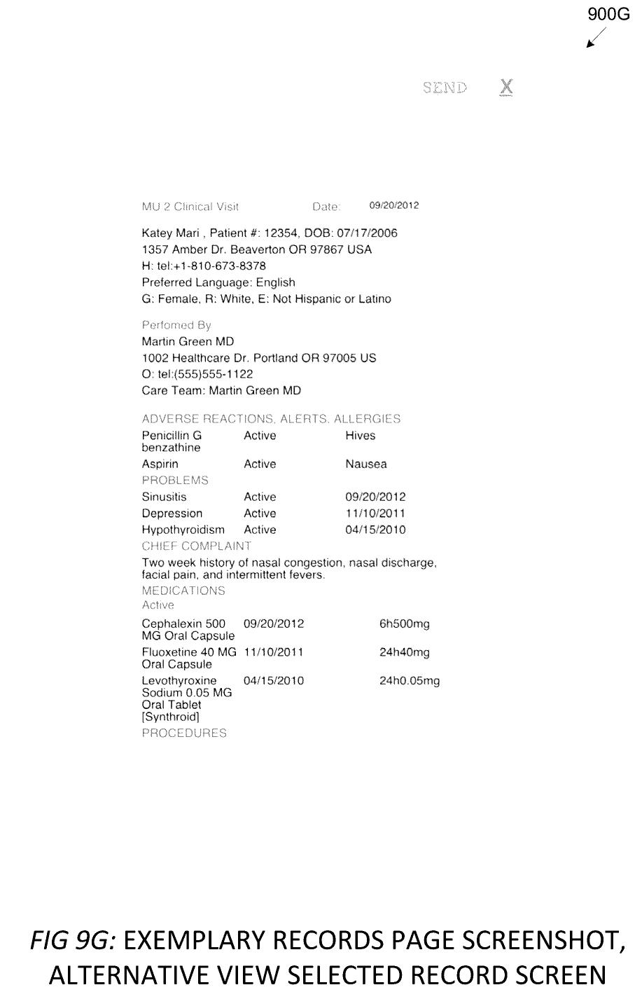

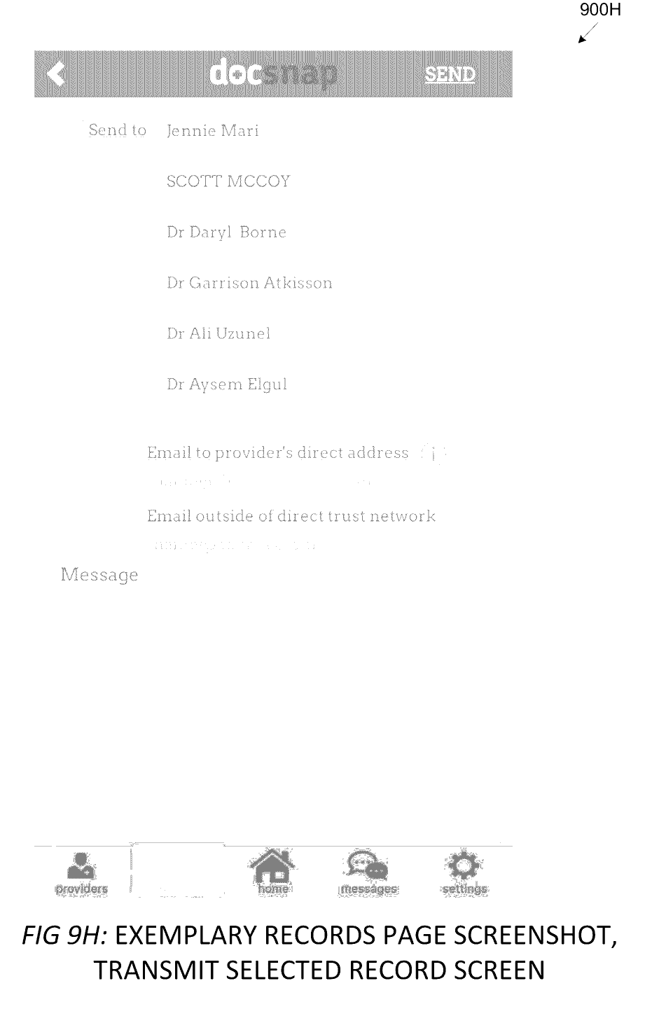

FIG. 9 (consisting of FIGS. 9A, 9B, 9C, 9D, 9E, 9F, 9G, and 9H) is a screenshot of an exemplary records page of a patient health network, according to one embodiment of the present disclosure. Generally, after selecting the records page, the patient is directed to either a screen 900A to select a particular patient for which to view records (as shown in FIG. 9A), corresponding to all of the patients within the system that the particular patient has permission to access their records, or a screen 900C (as shown in FIG. 9A) to select the particular records that the patient wishes to view. In one embodiment, after viewing screen 900A to select a particular patient, the patient may be directed to a screen 900B (as shown in FIG. 9B) to view all of the most recent information regarding the selected patient (e.g., upcoming appointments, recent medical records, messages, etc.) and select a particular action to take with respect to the selected patient (e.g., view a particular medical record, send/view a message, etc.). Thus, in one embodiment, while viewing screen 900C, the patient may select a particular medical record to either view or send, as shown in FIG. 9D. Selecting a particular record to view generally displays the particular record, as shown in FIGS. 9E-G. Alternatively, selecting a particular record to transmit generally takes the patient to a screen 900H (as shown in FIG. 9H) that accepts the contact information of the individual (e.g., medical provider, other patient, insurance carrier, etc.) that the patient wishes to send the particular record. In one embodiment, the system may remember and provide on screen 900H the most popular or recent contact information that the patient has used.

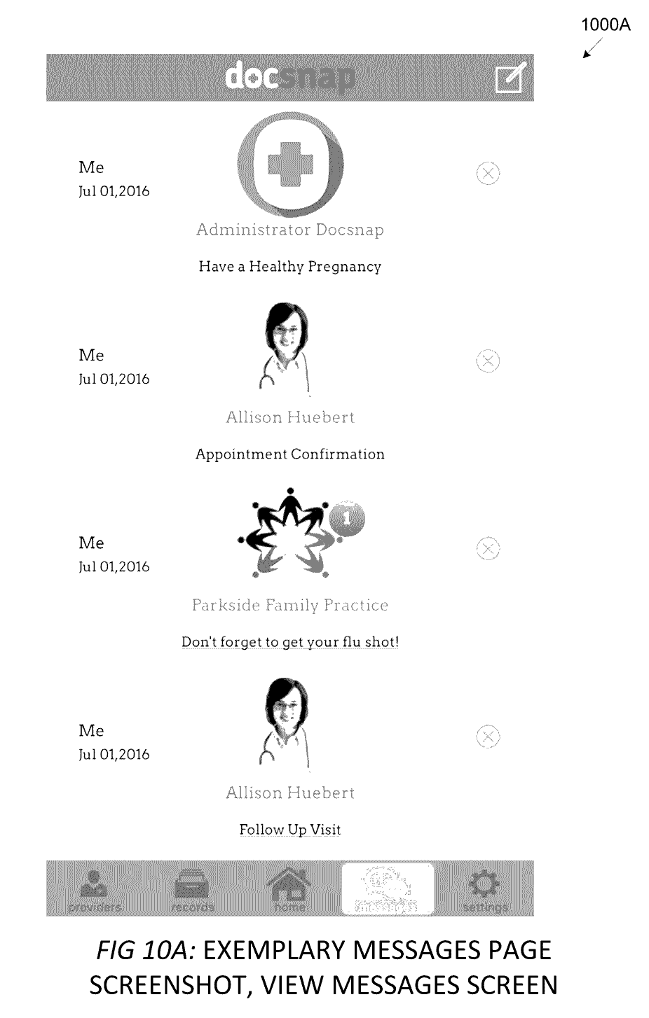

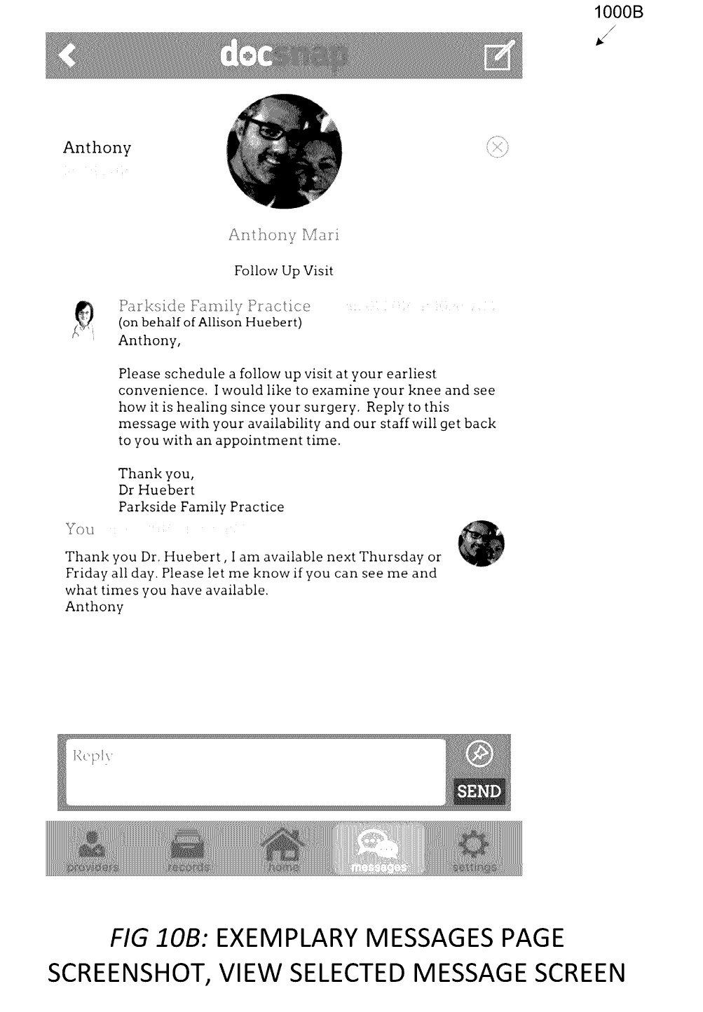

FIG. 10 (consisting of FIGS. 10A and 10B) is a screenshot of an exemplary messages page of a patient health network, according to one embodiment of the present disclosure. In one embodiment, as shown in FIG. 10A, a patient may, after selecting the messages page, view a screen 1000A that shows all of the messages that the particular patient has received. Generally, the patient may, as shown in FIG. 10B, view a particular message on a screen 1000B that enables the patient to respond to the sender of the message.

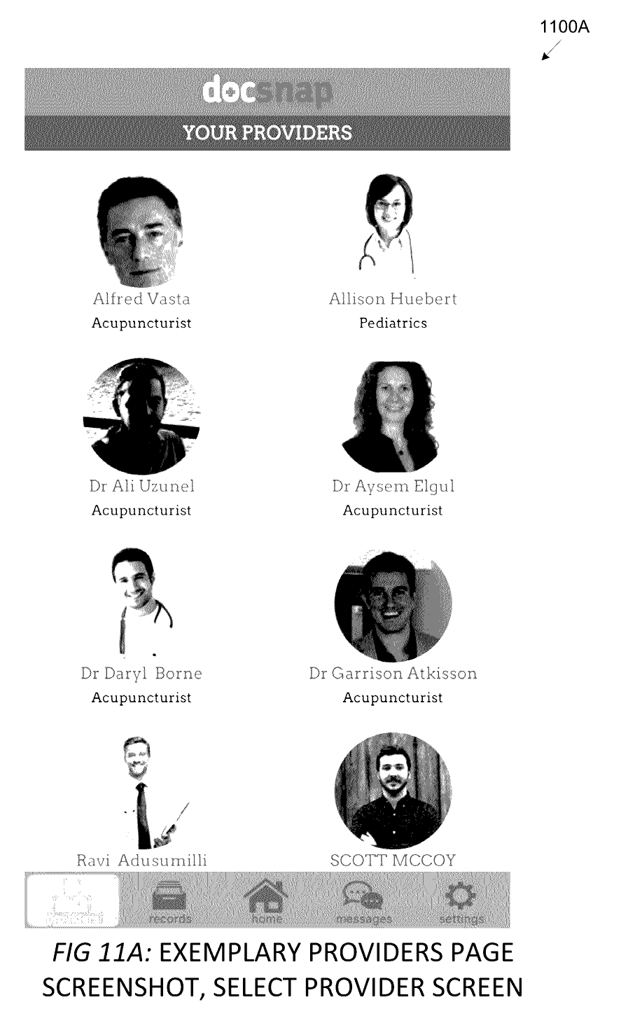

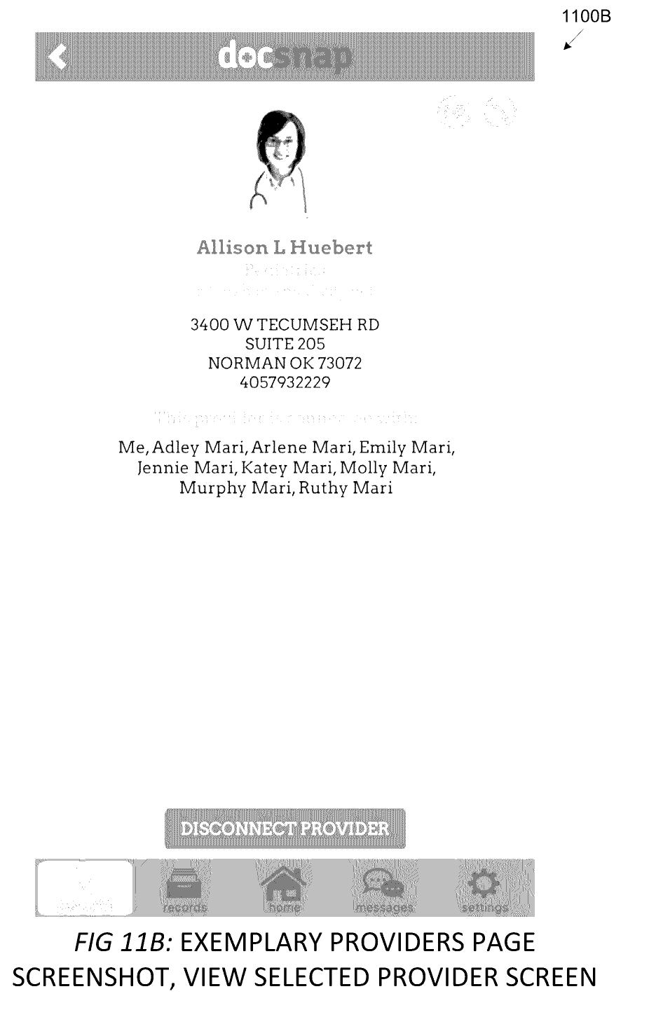

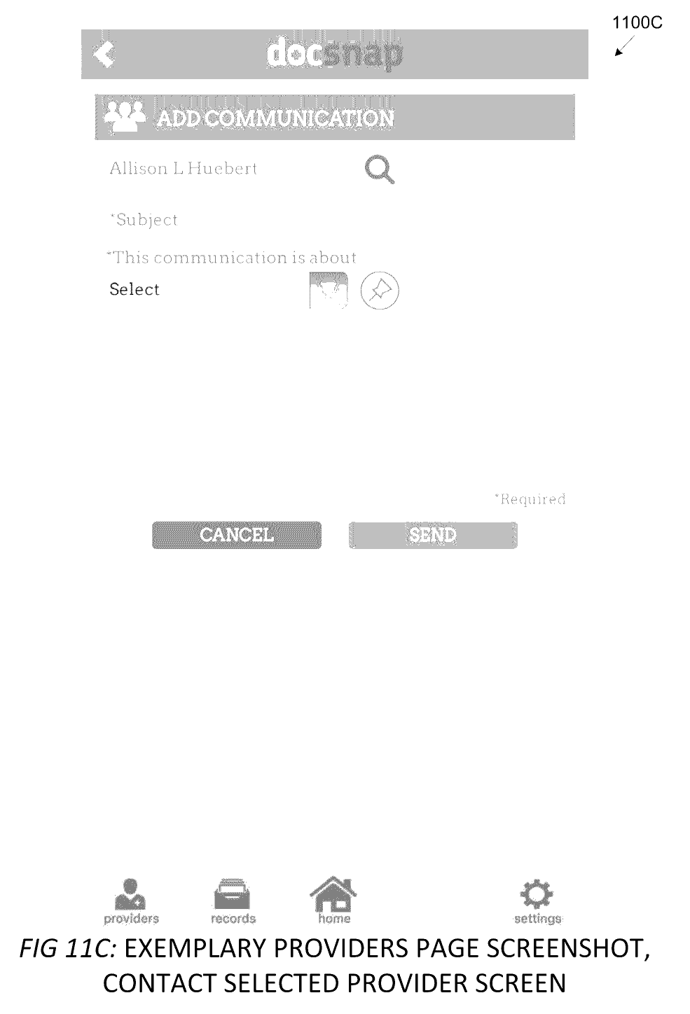

FIG. 11 (consisting of FIGS. 11A, 11B, and 11C) is a screenshot of an exemplary providers page of a patient health network, according to one embodiment of the present disclosure. In one embodiment, as shown in FIG. 11A, a patient may, after selecting the providers page, view a screen 1100A that shows all of the providers that are associated with that particular patient. By selecting a particular provider, the patient may, as shown in FIG. 11B, view a screen 1100B that shows the contact information of that particular provider and enables, as shown in FIG. 11C, the patient to send a message directly to the provider.

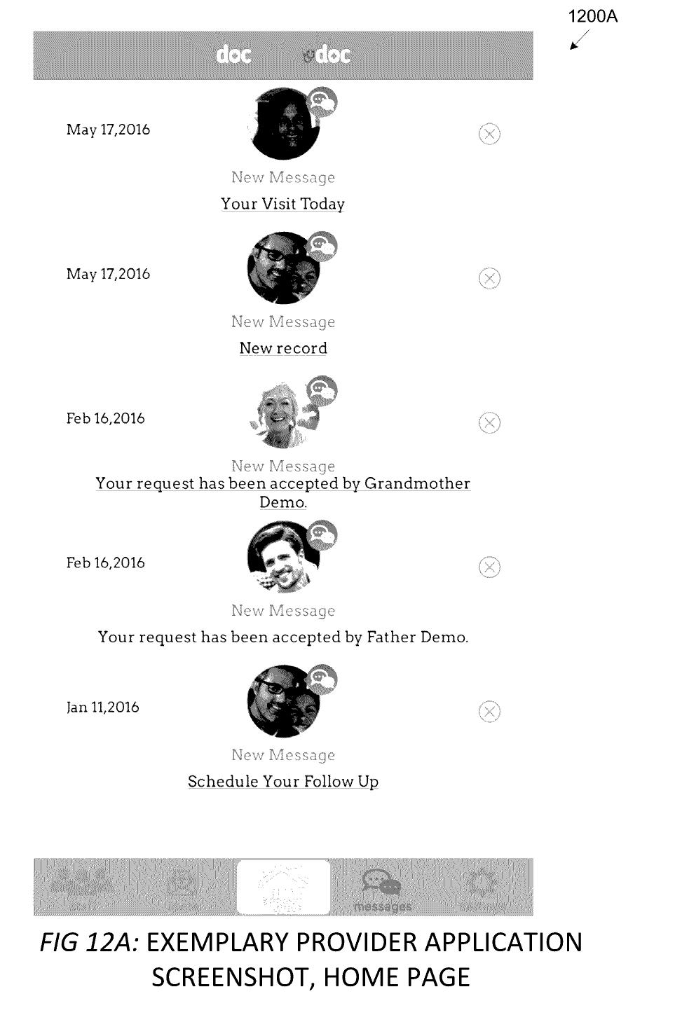

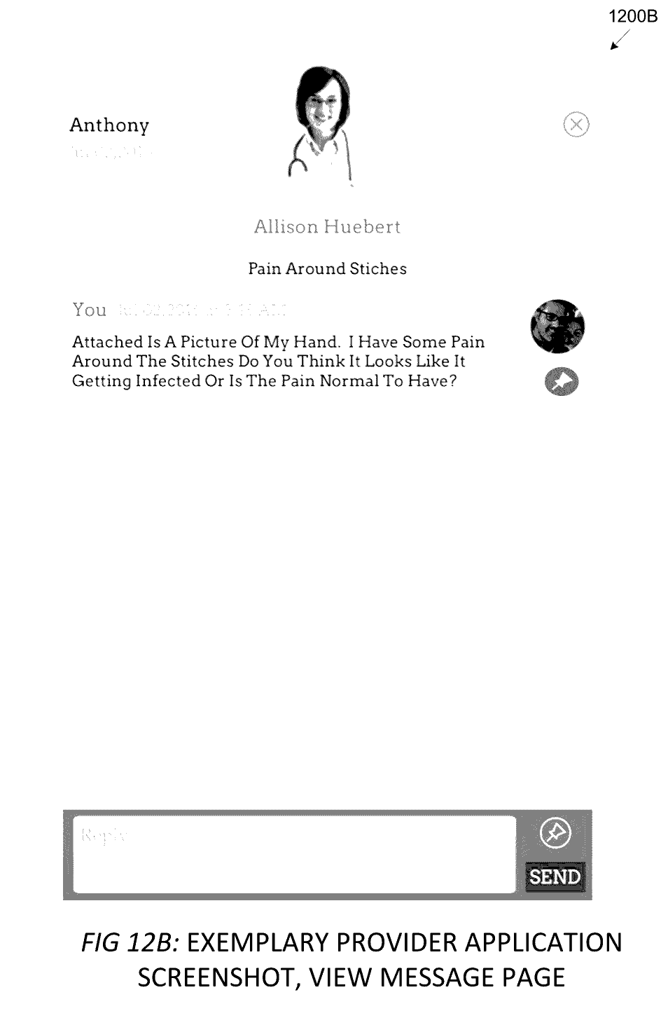

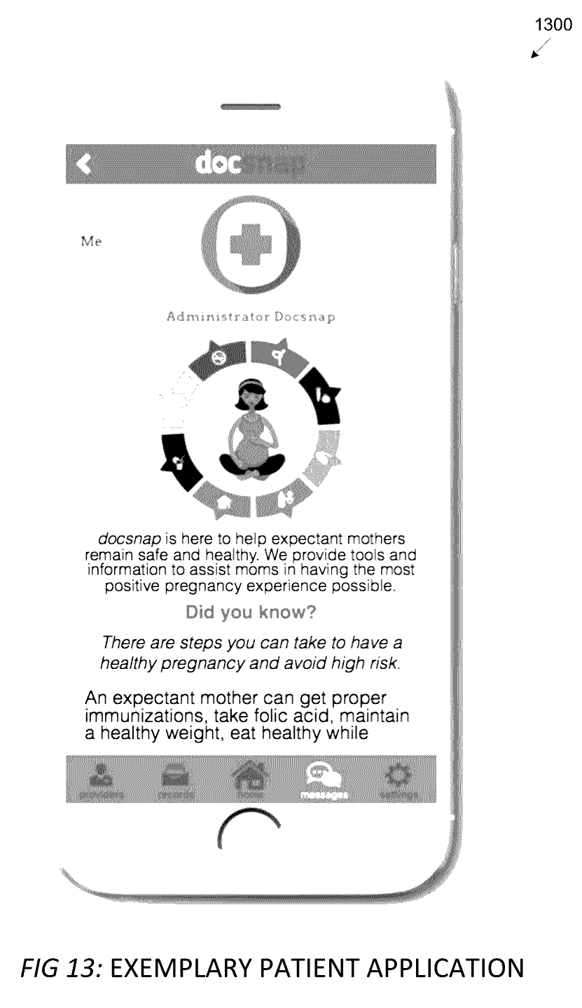

FIG. 12 (consisting of FIGS. 12A and 12B) is a screenshot of an exemplary provider application, according to one embodiment of the present disclosure. Generally, the provider application shown in FIG. 12 would be used by a medical provider to interact with patients, view medical records, and configure patient applications (shown in FIG. 13). Generally, as shown in FIG. 12A, the provider may view a home page 1200A that provides the most recent/relevant information regarding that provider (e.g., new messages, new medical records, upcoming appointments, etc.). By selecting a particular item on the home page 1200A, the provider will be taken to a page 1200B to view/interact with that item (e.g., read and respond to a message from a patient, etc.).

FIG. 13 is a screenshot of an exemplary patient application 1300, according to one embodiment of the present disclosure. This patient application 1300 permits a medical provider and/or a patient to manipulate their medical records using condition-specific workflows. For example, a pregnant patient or obstetrician may manipulate medical health records within a patient application 1300 that is designed to monitor a pregnant patient's progress throughout gestation, providing automatic alerts to both the provider and patient regarding important information (e.g., vital signs that indicate high risk, suggestions for actions to take to improve comfort, etc.). Generally, the patient application 1300 will also filter all of the patient's medical records to provide relevant information to the provider at the point of care. For example, based on a particular standard of care (e.g., the American College of Obstetricians and Gynecologist' 9-visit pathway for perinatal care), the patient application 1300 will display relevant data from the patient's last visit (e.g., vital signs, lab results, etc.), important inquiries for the provider to ask, certain measurements for the provider to take, etc. so that the provider knows exactly how to proceed during the patient's visit.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A computer-implemented method of facilitating creation of a patient health network, the method comprising:
providing a patient health network application to a plurality of patient health network patient members and potential patient members for installation on a computing device associated with each of the plurality of patient members and potential patient members;
receiving a request from a potential patient member at a patient vetting server via the patient health network application over the Internet to join the patient health network, the patient vetting server comprising one or more processors and a memory that stores one or more patient vetting requirements and information associated with the potential patient member, wherein the one or more processors:
in response to the request from the potential patient member to join the patient health network, authenticate the potential patient member based at least in part on the one or more patient vetting requirements and the information associated with the potential patient member;
in response to authenticating the potential patient member, generate first patient member account data for the potential patient member comprising the information associated with the potential patient member and associate the first patient member account data with a first patient member account; and
store the first patient member account data in the memory;
receiving, via a direct address associated with the patient health network, one or more electronic health records (EHRs) associated with the first patient member at a patient health network server sent from a data source over the Internet, the patient health network server comprising one or more processors and a memory that stores patient member account data for each of the plurality of patient health network patient members and one or more EHRs, wherein the one or more processors:
associate, in the memory, the one or more EHRs associated with the first patient member with the first patient member account;
receive a request from the first patient member via the patient health network application to view the one or more EHRs associated with the first patient member;
in response to the request to view the one or more EHRs associated with the first patient member, transmit the one or more EHRs associated with the first patient member over a wireless communication channel to a computing device associated with the first patient member, wherein:
the patient health network application causes the one or more EHRs associated with the first patient member to display on the computing device associated with the first patient member.

2. The computer-implemented method of claim 1, further comprising:
receiving, by one or more processors at the patient health network server, a request from the first patient member to transmit a first electronic health record (EHR) to a third party via the patient health network;
at least partially in response to receiving the request, formatting the EHR, by the one or more processors, based at least in part one or more clinical document architecture (CDA) standards to generate a formatted EHR;
transmitting, by the one or more processors, the formatted EHR over one or more networks to a third party server based on a direct address associated with the third party.

3. The computer-implemented method of claim 1, further comprising:
providing a patient health network application to a plurality of patient health network doctor members for installation on a computing device associated with each of the plurality of patient health network doctor members;
enabling, by the one or more processors, the plurality of patient members to connect with one or more of the plurality of doctor members via the patient health network;
receiving, at the patient health network server, from the first patient member via the patient health network application, a request to connect to a first doctor member, wherein:
in response to receiving the request to connect to the first doctor member, the one or more processors:
connect the first patient member to the first doctor member via the patient health network by:
associating, by one or more processors the first patient member account with a first doctor member account associated with the first doctor member in memory; and
enabling, by one or more processors, secure two-way communication between the first patient member and the first doctor member via the patient health care network application.

4. The computer-implemented method of claim 3, further comprising:
receiving, at the patient health network server, from the first patient member via the patient health network application, a request to transmit a first message to the first doctor member;
in response to the request to transmit the first message to the first doctor member, transmitting the first message over one or more networks to a computing device associated with the first doctor member based on one or more Health Insurance Portability and Accountability Act (HIPPA) compliance standards, wherein
the patient health network application causes the first message to display on the computing device associated with the first doctor member.

5. The computer-implemented method of claim 1, wherein:
the patient heather network server further comprises a memory that stores patient member account data for a second patient member account associated with a second patient member account, third patient member account data for a third patient member associated with a third patient member account, wherein the second patient account data comprises one or more second EHRs associated with the second patient member; and
the method further comprises:
receiving, by one or more processors at the patient health network server, from the second patient member via the patient health network application, a request to authorize the third patient member to view the second patient member account data;
in response to the request to authorize the third patient member to view the second patient member account data, associating, in memory by one or more processors, the second patient member account data with the third patient member account;
receiving, by a one or more processors from the third patient member via the patient health network application a request to view the second patient member account data;
in response to the request to view the second patient member account data, transmitting, by one or more processors, the second patient member account data over a wireless communication channel to a computing device associated with the third patient member, wherein:
the patient health network application causes the second patient member account data to display on the computing device associated with the third patient member while the third patient member is logged into the third patient member account via the patient health network application on the computing device associated with the third patient member.

6. The computer-implemented method of claim 5, wherein the method further comprises:
receiving, by one or more processors at the patient health network server, from the second patient member via the patient health network application, a request to authorize the third patient member to transmit the one or more second EHRs to a third party via the patient health network;
at least partially in response to receiving the request, authorizing the third patient member to transmit the one or more second EHRs.

7. The computer-implemented method of claim 6, wherein the method further comprises:
receiving, by one or more processors at the patient health network server, from the third patient member via the patient health network application, a request to transmit the one or more second EHRs to t third party via the patient health network;
formatting the one or more second EHRs, by the one or more processors, based at least in part on one or more clinical document architecture (CDA) standards to generate one or more formatted second EHRs; and
transmitting, by the one or more processors, the one or more formatted second EHRs over one or more networks to a third party server based.

8. The computer-implemented method of claim 1, wherein:
the patient heather network server further comprises a memory that stores patient member account data for a fourth patient member account associated with a fourth patient member account, fifth patient member account data for a fifth patient member associated with a fifth patient member account, wherein the fourth patient account data comprises one or more fourth EHRs associated with the fourth patient member; and
the method further comprises:
receiving, by one or more processors at the patient health network server, from the fifth patient member via the patient health network application, a request for authorization to view the fourth patient member account data;
in response to the request for authorization to view the fourth patient member account data, confirming an authority of the fifth patient member to view healthcare data for the fourth patient member;
in response to confirming the authority of the fifth patient member to view healthcare data for the fourth patient member, associating, in memory by one or more processors, the fourth patient member account data with the fifth patient member account;
receiving, by a one or more processors from the fifth patient member via the patient health network application a request to view the fourth patient member account data;
in response to the request to view the fourth patient member account data, transmitting, by one or more processors, the fourth patient member account data over a wireless communication channel to a computing device associated with the fifth patient member, wherein:
the patient health network application causes the fourth patient member account data to display on the computing device associated with the fifth patient member while the fifth patient member is logged into the fifth patient member account via the patient health network application on the computing device associated with the fifth patient member.

9. The computer-implemented method of claim 8, wherein:
the fifth patient member is a parent of the fourth patient member; and
the fourth patient member is minor child.

10. A computer-implemented method for forming a secure patient network for transmitting healthcare data between the secure patient network and a secure doctor network, the method comprises:
a. creating, by a processor, a key for a secured patient network;
b. receiving a request, by a processor, from a first patient to establish an account on the secured patient network;
c. at least partially in response to receiving the request, creating, by a processor, an account for the first patient;
d. assigning, by a processor, a sub-key to the first patient, wherein the sub-key is at least partially based on the key;
e. facilitate, by a processor, uploading of patient healthcare information to the first patient's account;
f storing, by a processor, the uploaded first patient healthcare information in the first patient's account on the secured patient network;
g. receiving, by a processor, from the first patient a request to transmit the uploaded first patient healthcare information to a first doctor having an account on a first secure doctor network; and
h. at least partially in response to receiving the request to transmit the uploaded first patient healthcare information to the first doctor, facilitating, by a processor, transmission of the uploaded first patient healthcare data to the first doctor on the first secure doctor's network.

11. The computer-implemented method of claim 10, wherein the step of storing the uploaded first patient healthcare information further comprises:
a. automatically formatting, by a processor, the uploaded healthcare information into a standard healthcare record format; and
b. appending the formatted healthcare information to an electronic healthcare record for the first patient in the first patient's account.

12. The computer-implemented method of claim 10, further comprising the step of:
a. receiving, by a processor, information from a second doctor having an account on a second secure doctor network;
b. automatically parsing, by a processor, the received information for a second sub-key contained in the received information, wherein the second sub-key is at least partially based on the key;
c. determining, by a processor, a second patient assigned the second sub-key;
d. formatting, by a processor, the received information into a standard healthcare record format; and
e. storing, by a processor, the formatted information in an account for the second patient associated with the second sub-key.

13. The computer-implemented method of claim 12, wherein the first sub-key and the second-sub-key are the same sub-key and the second patient is the same as the first patient.

14. The computer-implemented method of claim 10, further comprising:
a. receiving, by a processor, from the first patient, a request to authorize a second user having an account on the secured patient network to view the first patient healthcare information;
b. at least partially in response to receiving the request, authorizing the second user to view the first patient healthcare information.

15. The computer-implemented method of claim 14, further comprising:
c. providing, by a processor, a patient health application for installation on a computing device associated with the second user;
d. receiving, by a processor, from the second user via the patient health application, a request to view the first patient healthcare information;
e. at least partially in request to receiving the request to view the first patient healthcare information, causing the patient health application to display the first patient healthcare information on the computing device associated with the second user.
